(19) United States
(12) Patent Application Publication
(10) Pub. No.: US 2012/0060093 A1
(43) Pub. Date: Mar. 8, 2012

(54) MULTIMEDIA FILE PLAYING METHOD AND MULTIMEDIA PLAYER

(76) Inventor: Doohan Lee, Seoul (KR)

(21) Appl. No.: 13/320,451

(22) PCT Filed: May 13, 2010
(86) PCT No.: PCT/KR2010/003023

§ 371 Date: Nov. 14, 2011

(30) Foreign Application Priority Data
May 13, 2009 (KR) 10-2009-0041502
Jun. 5, 2009 (KR) 10-2009-0049680
Aug. 21, 2009 (KR) 10-2009-0077863
Sep. 14, 2009 (KR) 10-2009-0086262
Nov. 30, 2009 (KR) 10-2009-0116362
Jan. 19, 2010 (KR) 10-2010-0004564
Feb. 16, 2010 (KR) 10-2010-0013737
May 12, 2010 (KR) 10-2010-0044326

(51) Int. Cl. G06F 3/048; G06F 17/30

(52) U.S. Cl. 715/716; 707/752; 707/E17.01; 707/E17.009; 707/E17.101

(57) ABSTRACT

The present invention relates to a multimedia file playing back method for playing audio and video contents for more effective language learning, and to a multimedia player. More particularly, the present invention relates to a multimedia file playing back method and a multimedia player, wherein file(s) to be played back are multimedia file(s) such as MP3, WMV or AVI file(s), said method comprising: a file loading (9) step in which a specific frame is selected as the file playback time base, at least one pause markers (51) recording the time code for the frame is defined, multimedia files (50) stored in the file metadata area are sorted by filename, and a multimedia file is loaded into the playback program; a file selection step (10) in which a multimedia file is selected; a file playback step (12) in which the selected multimedia file is played back; a pausing step (13) in which a control means (34) detects the pause markers (51), and playback is paused at the applicable frame; a playback switch operation step (14) in which the pause function is released by operating a switch means (32) after the completion of a learning exercise such as attempting to respond to, repeating or writing down a played-back sentence using the pause time; and a file playback step (12) in which the file is played back again, wherein a foreign language is learnt while one or more multimedia files stored in a folder are played back sequentially by repeating the file playback step (12), the pausing step (13) and the switch operation step (14).

### TECHNICAL FIELD

The present invention relates to a method of playing back a multimedia file and a player for playing back the multimedia file and relates to a method of playing back a multimedia file, including a file load step 9 of selecting a specific frame of a played file (i.e., a multimedia file, such as MP3, WMV, and AVI) based on the playback time axis of the multimedia file, defining one or more pause markers 51 on which the time codes of the specific frame are recorded, sorting the multimedia file 50 stored in the metadata region of the multimedia file in the order of file name, and loading the multimedia file 50 into a playback program, a file selection step 10 of selecting the multimedia file 50, a file playback step 12 of playing back the selected multimedia file, a pause step 13 of temporally stopping playback in a relevant frame by detecting the pause markers 51 through control means 34, a playback switch manipulation step 14 of answering a played sentence using the pause time or releasing the pause by manipulating switch means 32 after completing various studies, such as shadowing or a dictation, and the file playback step 12 of playing back the file again, wherein the file playback step 12, the pause step 13, and the switch manipulation step 14 are repeated and a foreign language is studied while sequentially playing back one or more multimedia files stored in a folder, and a player for playing back the multimedia file.

### BACKGROUND ART

When learning a foreign language using a conventional multimedia player, such as an MP3 player or a portable multimedia player (PMP), a person learnt a language study content file, such as MP3, WMV, and AVI while playing, following, and pronouncing the language study content file. Alternatively, if a learner tries to listen to or follow a specific sentence or to perform active study, such as a dictation, the learner had to play back an audio or video file, pause the file by manipulating the pause switch of a relevant player, and then learn the file again while manipulating a playback switch.

### DISCLOSURE

### Technical Problem

A multimedia player, such as an MP3 player and a PMP, is a device that originally plays and enjoys music or a movie, but these days a lot of foreign language learners play back language study content and learn foreign languages using the multimedia player. However, the multimedia player has been used for simple study purposes for pronouncing words, while playing and following a multimedia file, because the multimedia player does not have a specialized language study function. It is actually difficult to learn a foreign language using the passive foreign language learning method. In order to learn a foreign language more effectively, it is better for a learner to learn the foreign language while actively thinking directly. For example, it is effective for a learner to directly tell a reply or a correct answer, while thinking, after listening to a certain question or query through a native speaker or a multimedia player. If a learner 25 studies by listening to a question part English audio 21, such as a sample sentence below, through a multimedia player 30 and directly answering an answer part English audio 22, there is a learning effect that the learner actually has a conversation with a foreigner.

Are you Korean? Question

Yes, I am. I'm Korean. Answer

Are you busy now? Question

No, I'm not. I'm free. Answer

If the learner 25 studies by first listening to a Korean part audio 23 below, while playing back pieces of content of Korean and English sequentially played back, through the multimedia player 30 and then directly telling an English part audio 24, an English conversation effect and an English composition learning effect may be obtained. [symbol] [symbol] ?

Are you Korean?

[symbol] , [symbol] . [symbol] [symbol] .

Yes, I am. I'm Korean.

Furthermore, if the learner 25 studies by listening to each English sentence, such as a sample sentence below, while playing back the English sentence through the multimedia player 30, and then directly making a dictation, an English listening effect and a composition learning effect may be obtained.

I like to chat with friends on the internet.

I used to live in San Francisco for a long time.

I hope you have a good time in New York.

In addition, several efficient foreign language studies are possible, such as following foreign language words, following the foreign language words and making a dictation, speaking Korean after listening to words in a foreign language, and speaking a foreign language after listening to words in Korean, while playing back the foreign language words.

In order for a learner to give an answer and do dictation studies when the language study content is played back or studied using the existing multimedia player, the learner had to inconveniently perform a series of studies by playing a file and then temporally stopping the file by directly manipulating a pause switch and to inconveniently learn the file while playing back the file again by manipulating a playback switch, in order to make the learning time. Furthermore, efficient foreign language learning cannot be made because of inconvenience, such as that the middle part of a next sentence is almost paused after the next sentence is played back.

### TECHNICAL SOLUTION

The present invention relates to a method of playing back a multimedia file and a player for playing back the multimedia file which have been made to maximize language study by solving the conventional problems. The present invention provides a method of playing back a multimedia file, including a file load step 9 of selecting a specific frame of a played file (i.e., a multimedia file, such as MP3, WMV, and AVI in a multimedia playback program for playing back a multimedia file) based on the playback time axis of the multimedia file, defining one or more pause markers 51 on which the time codes of the specific frame are recorded, sorting the multimedia file 50 stored in the metadata region of the multimedia file in the order of file name, and loading the multimedia file 50 into a playback program, a file selection step 10 of selecting the multimedia file 50, a file playback step 12 of playing back the selected multimedia file, a pause step 13 of temporally stopping playback in a relevant frame by detecting the pause markers 51 through control means 34, a playback switch manipulation step 14 of answering a played sentence using the pause time or releasing the pause by manipulating switch means 32 after completing various studies, such as follow or a dictation, and the file playback step 12 of playing back the file again, wherein the file playback step 12, the pause step 13, and the switch manipulation step 14 are repeated and a foreign language is studied while sequentially playing back one or more multimedia files stored in a folder, and a player for playing back the multimedia file.

### ADVANTAGEOUS EFFECTS

As described above, according to the present invention, a multimedia player for listening to music and watching video becomes an effective language study-dedicated player by adding the playback function of the present invention to the existing multimedia player for playing back multimedia files, such as a MP3 player and a PMP. Accordingly, there is an effect that foreign language study can be maximized because various language study effects, such as conversation learning that the learner 25 makes an answer while actively thinking directly, dictation learning that the learner 25 can make a dictation while listening to an English sentence or words, and writing learning that the learner 25 speaks a foreign language or writes a composition while listening to or watching the foreign language in Korean, can be conveniently obtained. Furthermore, in the existing language study machine, a learner cannot select and learn another language study teaching materials using a dedicated file format. However, the multimedia playback program and the multimedia player 30 supporting the playback function have excellent compatibility because they use common multimedia file formats, such as MP3, WMV, and AVI files, and are advantageous in that a learner can record the audio and video attachment files of favorite language study teaching materials or foreign language broadcasting, news, and dramas, simply modify the files, and use the files in the multimedia playback program and the multimedia player.

### DESCRIPTION OF DRAWINGS

FIG. 1 is a sequential flowchart according to an embodiment of the present invention.

FIG. 2 is a diagram that language study is made according to an embodiment of the present invention.

FIG. 3 is a diagram that language study is made according to an embodiment of the present invention.

FIG. 4 is a diagram of a multimedia file according to an embodiment of the present invention.

FIG. 5 is a diagram of a multimedia file according to an embodiment of the present invention.

FIG. 6 is a diagram of a multimedia file without a marker according to an embodiment of the present invention.

FIG. 7 is a diagram of a multimedia file according to an embodiment of the present invention.

FIG. 8 is a diagram of a caption script file according to an embodiment of the present invention.

FIG. 9 is a diagram of a caption script file according to an embodiment of the present invention.

FIG. 10 is a diagram of a caption script file according to an embodiment of the present invention.

FIG. 11 is a diagram of a caption script file according to an embodiment of the present invention.

FIG. 12 is a diagram of a playback list according to an embodiment of the present invention.

FIG. 13 shows the construction of a multimedia player according to an embodiment of the present invention.

FIG. 14 is a diagram showing a multimedia VOD system according to an embodiment of the present invention.

### DESCIPTION OF REFERENCE NUMERALS OF PRINCIPAL ELEMENTS IN THE DRAWINGS

9: file load step

10: playback setting step

11: file selection step

12: file playback step

13: pause step

14: playback switch manipulation step

15: pause release step

20: title part English audio

21: question part English audio

22: answer part English audio

23: Korean language part audio

24: English part audio

25: learner

30: multimedia player

31: display means

32: switch means

33: setting means

34: control means

35: storage means

36: interface means

37: analog conversion means

38: output means

39: microphone input means

50: multimedia file

50B: multimedia file without marker

51: pause marker

52: pass marker

53: chapter marker

54: skip marker

55: variable marker

58: start part of the multimedia file

59: end part of the multimedia file

60: caption script file

61: caption chapter marker

62: caption pass marker

63: caption pause marker

64: caption skip marker

66: caption in time tag

67: caption out time tag

68: caption time tag

68b: consecutive caption time tag

69: blank character string caption time tag

70: playback list

71: VOD server

72: network

73: client terminal

### MODE FOR INVENTION

A method of playing back a multimedia program file, a multimedia player, and a method of producing content according to embodiment of the present invention are described in detail below.

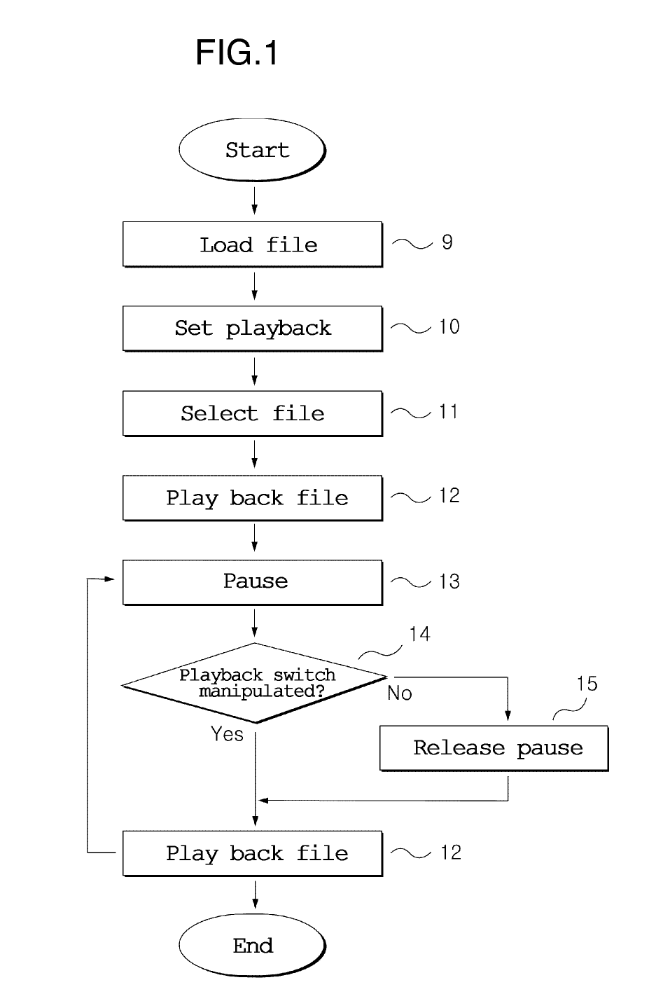

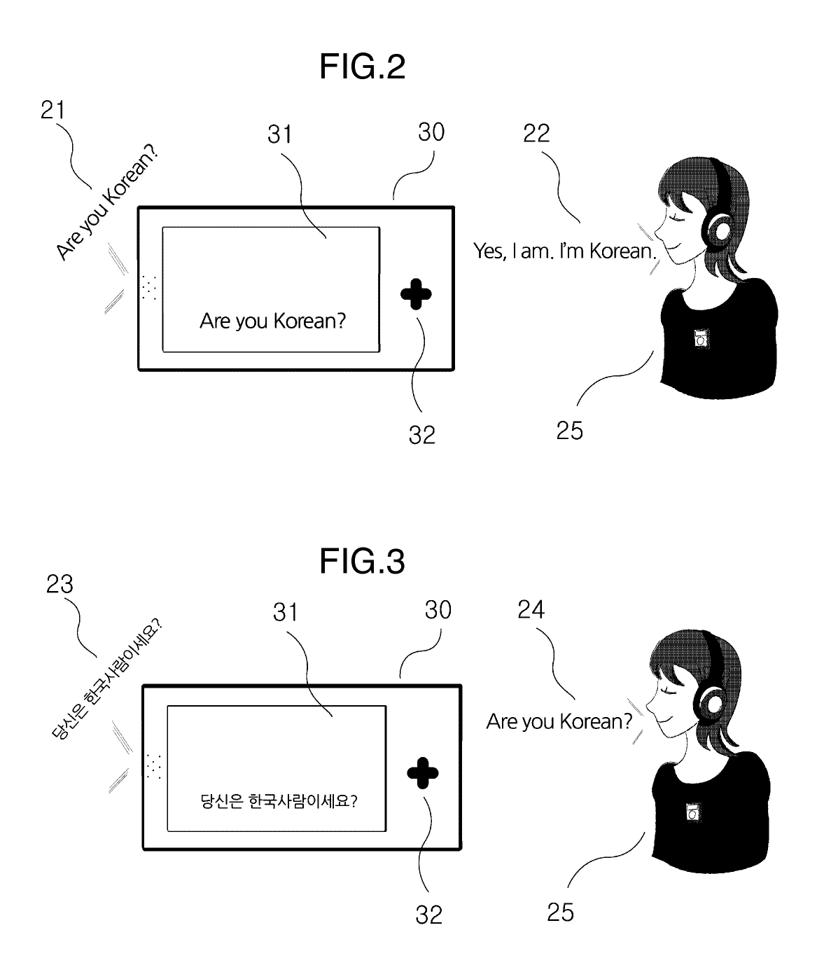

FIG. 1 is a sequential flowchart according to an embodiment of the present invention. A method of playing back a multimedia file includes a file load step 9 of a learner 25 sorting one or more multimedia files stored in a folder in the order of file name and loading the multimedia files into a multimedia playback program for playing backing the multimedia file, a file selection step 11 of the learner 25 selecting the file, a file playback step 12 of the learner 25 playing backing the selected multimedia file, a pause step 13 of the learner 25 temporally stopping the playback at end part of the multimedia file 59 using control means 34 when the playback of the multimedia file is ended, a playback switch manipulation step 14 of the learner 25 directly answering a played sentence using the pause time or completing various studies, such as follow or a dictation and then releasing the pause by manipulating switch means 32, and a file playback step 12 of playing back a next file, wherein the learner 25 learns a foreign language while repeating the file playback step 12, the pause step 13 of temporally stopping playback, and the switch manipulation step 14 and sequentially playing back the one or more multimedia files stored in the folder.

The present invention relates to a method of playing back a multimedia file further includes a playback setting step 10 of setting the number of times of playbacks and the pause release time in setting means 33 in a multimedia playback program, the file playback step 12 of repeatedly playing back the file by the set number of times of playbacks, and a pause release step 15 of automatically releasing a pause key if the playback switch manipulation step 14 is not performed until a pause release time set in the setting means 33 in the pause step 13, wherein the learner 25 learns a foreign language while sequentially playing back the one or more multimedia files stored in the folder. Here, the number of times of playbacks may be set to one, two times, three time, . . . , infinite repeat and the setting time in the pause release step 15 may be set to 1 second, 2 seconds, 3 seconds, . . . , infinity (invalidation) so that the learner 25 can study while repeatedly playing back the one or more multimedia files according to his learning ability and learning method.

The present invention relates to a method of playing back a multimedia file, wherein when a soundless part for some time or more in an audio signal of a file is detected by the control means 34 in the pause step 13 in a multimedia playback program, the playback of the multimedia file is paused. Even in the present invention, the number of times of playbacks and the pause release time can be set in the setting means 33, the files can be repeatedly played back by the number of times of playbacks, the pause can be automatically released when the pause release time elapses, and the files can be sequentially played back, for convenience of learning.

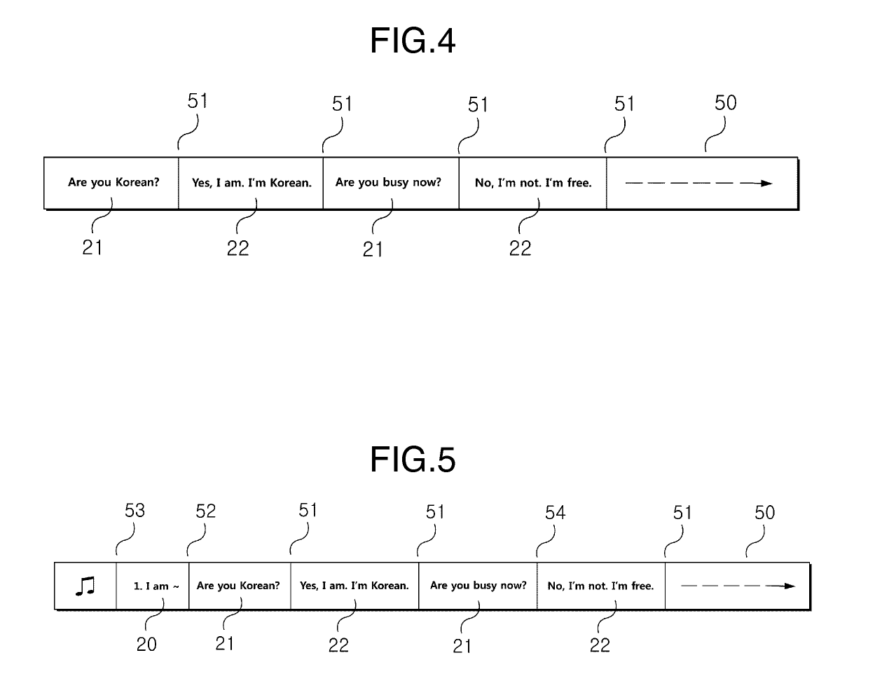

FIG. 4 is a diagram of a multimedia file according to an embodiment of the present invention. A multimedia file that is chiefly used, such as MP3 or WMV, includes a main data region in which voice and video data are stored and a metadata region in which artist information, a song title, a copyright, a title image, etc. are stored. The attribute information is stored in an MP3 file in a metadata format according to the ID3 tag standard. In the present invention, various pieces of marker information, such as pause markers, are defined in the metadata region of the multimedia file in a special character string, time codes are recorded, and the multimedia file is stored again by using a content production marker program of the present invention. The multimedia file in which the marker information is stored is loaded into the multimedia playback program and the multimedia player of the present invention, the markers are detected by the control means 34, and the multimedia file is paused and played back again, thereby implementing various learning functions. Furthermore, in case of a multimedia file not including the metadata region, such as an AVI file, a metadata region is randomly produced, markers are defined in the metadata region in a special character string, and various pieces of marker information are stored, thereby being capable of implementing the learning function of the present invention. The learning function of the present invention can also be implemented for other multimedia files and other multimedia container formats by using the method.

In the present invention, in order to implement a more effective learning function in a multimedia playback program using a common multimedia file, a specific frame is selected based on the playback time axis of a file, the one or more pause markers 51 on which time codes thereof are recorded are defined and stored in the metadata region of the multimedia file, and the file is then stored again by using the content production marker program of the present invention. When the learner 25 loads the multimedia file 50 into the playback program, selects the file, and plays back the selected multimedia file, the control means 34 detects the pause markers 51 and temporally stops the playback of the multimedia file at the marker frame. The learner 25 directly answers a played sentence using the pause time or performs various studies, such as follow or a dictation. After the studies are completed, the learner 25 releases the pause by manipulating the switch means 32 in order to play back the file again. The present invention relates to a method of playing back a multimedia file, wherein as described above the control means 34 detects the pause markers 51, repeats the file playback step 12, the pause step 13, and the switch manipulation step 14, and sequentially plays back the multimedia file 50 so that the learner can learn a foreign language.

According to the present invention, in the multimedia playback program, the multimedia file 50 in which the pause markers 51 are recorded on the metadata region of a file is loaded into the playback program, and the number of times of playbacks and a pause release time are set in the setting means 33 in the playback setting step 10, for convenience of learning. When the file is selected and played back, the control means 34 repeatedly plays back the pause markers 51 of the multimedia file by the number of times of playbacks set in the setting means 33, detects the pause markers 51, and temporally stops the playback of the multimedia file at the marker frame. If the learner 25 directly answers a played sentence using the pause time, performs various studies, such as follow or a dictation, releases the pause by manipulating the switch means 32 after the studies are completed, plays back the file again, and does not perform the playback switch manipulation step 14 until the pause release time set in the setting means 33, the pause is automatically released. The present invention, as described above, relates to a method of playing back a multimedia file, in which the control means 34 detects the pause markers 51 and repeats the file playback step 12, the pause step 13, the switch manipulation step 14, and the pause release step 15 so that the learner 25 learns a foreign language while sequentially playing back the multimedia file 50.

FIG. 5 is a diagram of a multimedia file according to an embodiment of the present invention. In order to provide a more specialized learning function, a specific frame is selected based on the playback time axis of a file, the one or more pause markers 51, the one or more pass markers 52, the one or more chapter markers 53, and the one or more skip markers 54 on which time code thereof are stored are defined and recorded on the metadata region of the multimedia file, and the file is stored again by using the content production marker program of the present invention. When the learner 25 loads the multimedia file 50 in the playback program, the number of times of playbacks and the pause release time are set in the setting means 33 in the playback setting step 10, for convenience of learning, and the learner 25 selects a file and plays back the selected multimedia file. The control means 34 repeatedly plays back between-the pause markers 51 by the number of times of playbacks set in the setting means 33, detects the marker frames, and passes through playback at the chapter markers 53, but may perform playback from a relevant marker frame. The control means 34 passes through a marker frame in the pass marker 52, but performs playback from a relevant part when the multimedia file is rewound, skips playback in the skip markers 54, and temporally stops playback in the pause markers 51. If the learner 25 directly answers a played sentence using the pause time, performs various studies, such as shadowing or a dictation, releases the pause by manipulating the switch means 32 after the studies are completed, plays back the file again, and does not perform the playback switch manipulation step 14 until the pause release time set in the setting means 33, the pause is automatically released. The present invention relates to a method of playing back a multimedia file, wherein as described above, the control means 34 detects several kinds of the markers and repeats the file playback step 12, the pause step 13, the switch manipulation step 14, and the pause release step 15 so that the learner 24 can study a foreign language while sequentially playing back the multimedia file 50. The pass marker 52 of the title part English audio 20 of FIG. 5 is a title part and thus pause is not performed at the marker. However, if the learner learns a next English audio 21 and tries to perform playback again or repeatedly play a relevant part, the first part of the sentence is played. The chapter marker 53 is for enabling a desired chapter to be easily found and played back.

The present invention relates to a method of playing back a multimedia file, further including the voice playback switch manipulation step 14 in which in the multimedia playback program, when a specific voice signal, such as ‘Next’ or ‘ [symbol] ’, is generated in the pause step 13, the microphone input means 39 detects the voice signal and pause is released by the control means 34, so that the learner can learn a foreign language while sequentially playing the multimedia file.

The present invention relates to a method of playing back a multimedia file, further including a function in which the control means 34 performs pause in the pause step 13 if any voice signal is not detected by microphone input means 39 for some time after voice, such as answer, composition, or interpretation is generated in the multimedia playback program so that the learner can learn a foreign language while sequentially playing back a multimedia file.

The present invention relates to a method of playing back a multimedia file in a multimedia playback program, in which the learner 25 studies a foreign language, while changing the pause markers 51 of words or a sentence into the skip markers 54 by using the switch means 32 after repeatedly learning the words or the sentence several times and fully studying them, learning the file while sequentially playing back the file, storing the modified skip markers 54 in the metadata region of the multimedia file, and storing the file again. The words or the sentence changed into the skip markers 54 are not played back in next playback and are skipped, so that the learning time can be reduced and more efficient learning can be performed.

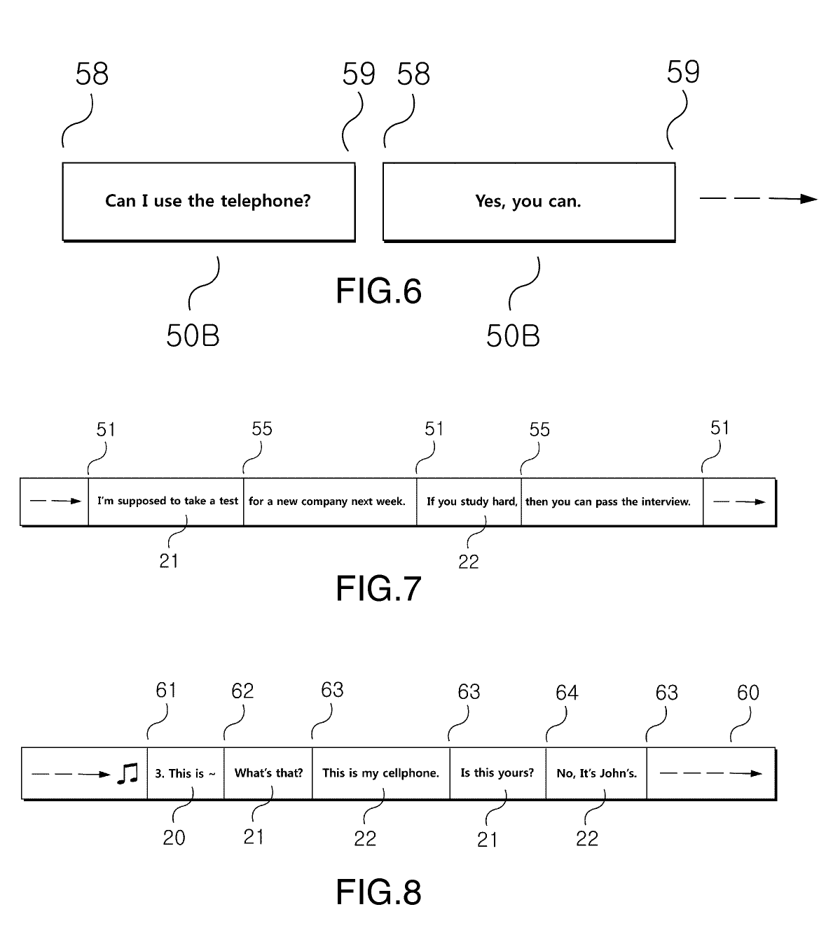

FIG. 6 is a diagram of a multimedia file without a marker according to an embodiment of the present invention. The present invention relates to a method of playing back a multimedia file in a multimedia playback program, in which a specific frame is selected based on the playback time axis of a multimedia file, the one or more chapter markers 53, the one or more pass markers 52, the one or more pause markers 51, and the one or more skip markers 54 on which time codes thereof are recorded are defined, and the multimedia file 50 and a multimedia file 50B without a marker, stored in the metadata region of the multimedia file, are sorted in the order of name and loaded into the playback program. The control means 34 detects each of the markers and performs control so that the chapter markers 53 are normally passed, but playback is started from a relevant part, the pass markers 52 are passed, but playback is performed from a relevant marker when the multimedia file is rewound, playback is skipped in the skip markers 54, and playback is paused in the pause markers 51. When the multimedia file 50B without a marker is played back, the start part 58 of the multimedia file is passed and playback is performed like the chapter markers 53, but playback is started from a relevant part, and the end part of the multimedia file 59 is always paused like the pause markers 51.

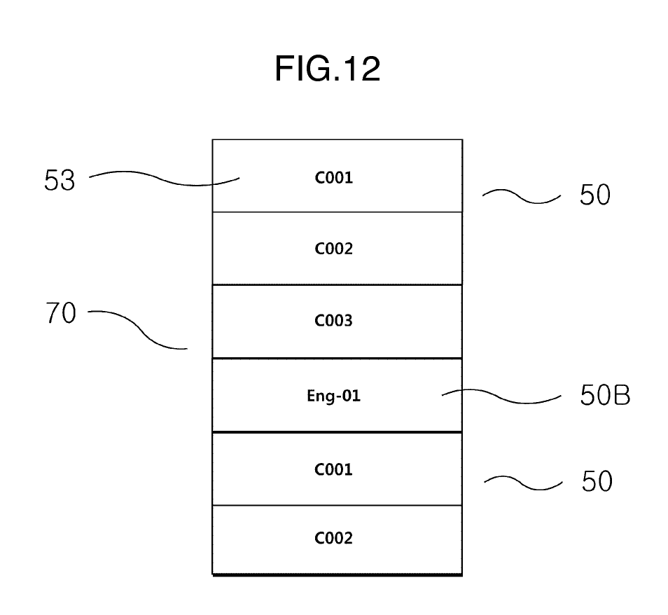

FIG. 12 is a diagram of a playback list according to an embodiment of the present invention. The present invention relates to a method of playing back a multimedia file in a multimedia playback program, in which a specific frame is selected based on the playback time axis of a multimedia file, the one or more chapter markers 53, the one or more pass markers 52, the one or more pause markers 51, and the one or more skip markers 54 on which time codes thereof are recorded are defined, all the files of a folder in which the multimedia file 50, together with the multimedia file 50B without a marker, is stored in the metadata region of the multimedia file are sorted in the order of name to produce a playback list 70, the chapter markers 53 and the start part 58 of the multimedia file 50B without a marker are listed up in the same order, the playback list of the multimedia file 50 is loaded into the playback program so that a desired chapter can be selected and played back, and the multimedia file 50 is sequentially played back. The same chapter names, such as c001 and c002, may be modified to have good names so that they can be easily identified by a learner.

The present invention relates to a method of playing back a multimedia file in a multimedia playback program, in which a specific frame is selected based on the playback time axis of a multimedia file, the one or more chapter markers 53, the one or more pass markers 52, the one or more pause markers 51, and the one or more skip markers 54 on which time codes thereof are recorded are defined, each of the markers of the multimedia file 50 and the multimedia file 50B without a marker, stored in the metadata region of the multimedia file, are randomly mixed and randomly loaded into the playback program, and each of the markers and the multimedia file 50 without the marker are randomly played back.

According to the present invention, in the method of playing back a multimedia program file, when a mouse is placed under a playback screen or the playback screen is selected in the file playback step 12, a small thumbnail image of each of the chapter markers is displayed. When a learner selects a desired thumbnail, control is performed so that playback is started from the chapter marker. Furthermore, gauge bars indicating the respective markers are displayed in a playback scroll bar with different colors and thicknesses. For example, the chapter marker may be displayed with a thicker gauge bar and other markers may be displayed with thinner gauge bars with different colors so that a learner can easily identify each chapter and each marker. When a learner selects the gauge bar of a desired marker, control is performed so that playback is started from a relevant marker. As described above, the present invention relates to a method of playing back a multimedia file, in which the chapter markers and the markers are displayed with the thumbnails and the gauge bars, and a marker where a multimedia file is selected is immediately played back and effectively sequentially played back. In the present invention, a playback list may be produced on the basis of several kinds of markers and playback may be repeatedly based on the chapter markers, playback is started from an xx chapter xx marker, or playback may be repeated between specific markers. This function may also be used not only in the multimedia player, but also in a multimedia playback program and the plug-in web media player of an Internet web browser.

The present invention relates to a method of playing back a multimedia file in a multimedia playback program, further including the playback setting step 10 in which the multimedia file 50 being played, from which a specific frame is selected based on the playback time axis of a multimedia file and in which the one or more chapter markers 53, the one or more pass markers 52, the one or more pause markers 51, and the one or more skip markers 54 on which time codes thereof are recorded are defined is the multimedia file 50 stored in the metadata region of the multimedia file and variable markers 55 are set by the setting means 33. When the learner 25 sets the variable marker 55 as the pause marker 51 using the setting means 33, the control means 34 performs control so that the variable marker 55 is operated as the pause marker 51. When the variable marker 55 is set as the skip marker 54, the control means 34 performs control so that playback is skipped at the marker. When the variable marker 55 is set to be invalid, the marker does not perform any function.

FIG. 7 is a diagram of a multimedia file according to an embodiment of the present invention. It is difficult for a beginner to learn a long sentence like a sample sentence. However, if the variable markers are inserted for every phrase or paragraph, the beginner can easily learn the long sentence. The beginner may repeatedly play back, pause, and learn the long sentence for every phrase or paragraph by setting the variable marker 55 as the pause marker 51. However, a more advanced learner may efficiently learn the long sentence while repeatedly playing back and temporally stopping the long sentence by setting the variable marker 55 as invalidation. Furthermore, when studying a file having Korean interpretation behind English, a learner may study English and Korean interpretation at the same time by inserting the variable marker 55 between English and Korean and setting the variable marker 55 as invalidation. However, if the variable marker 55 is set as the skip marker 54, playback is skipped as the Korean part and only an English sentence may be played back and learnt. In addition, several methods of efficient learning are possible by using the function of the variable marker 55.

According to the present invention, in the multimedia playback program, when the control means 34 repeatedly performs playback between the pause markers 51 by the number of times of playbacks set in the setting means 33 in the file playback step 12, if there is a high audio signal close to the pause marker 51, the audio may be suddenly played back loudly. In order to prevent the sudden loud playback of the audio, the present invention relates to a method of playing back a multimedia file, in which a circuit for fading in a start audio signal when a file is repeatedly played back and for fading out an end part audio when a file is paused is added to the control means 34.

According to the present invention, in a multimedia playback program, the control means 34 repeatedly performs playback between markers by the number of times of playbacks and a pause release time set in the file playback step and performs playback by catching a marker frame so that the caption of a marker appears when the pause is performed in the pause marker 51 for more efficient learning. If a program is not precisely operated in unit of ±0 frames, however, the caption of a front marker may appear in its start part when playback is repeatedly performed. In order to prevent the phenomenon in which the caption of the former marker unnecessarily appears, the present invention relates to a method of playing back a multimedia file in which a function of starting playback from a specific frame at the rear part of a marker when playback is repeatedly performed is added.

The present invention relates to a method of playing back a multimedia file, in which a function of repeatedly performing playback without a pause time in the number of times of playbacks in the front part and temporally stopping the playback by a pause time only in the number of times of playbacks at the last part, when the control means 34 repeatedly performs playback between the pause markers 51 by the number of times of playbacks set in the file playback step in the multimedia playback program for efficient repetitive listening and learning. For example, when studies are performed by setting the number of times of playbacks to three times and a pause release time to 5 seconds, pause is not performed in first and second playbacks in the front part, but the pause is performed for 5 seconds only in the last play. In this case, a learner continues to pronounce until twice playbacks and answers only in the last play, so that various studies, such as an answer and a dictation, can be efficiently performed.

The present invention relates to a method of playing back a multimedia file in a multimedia playback program, in which a specific frame is selected based on the playback time axis of a multimedia file, one or more pause markers 51 on which time code thereof are recorded are defined and stored in the metadata region of the multimedia file, a specific frame is selected from the metadata region of the same file name on the basis of the playback time axis of the multimedia file, several caption markers are captured, and the multimedia file 50 in which image data, such as JPG and PNG, or text is stored in the metadata region of the multimedia file is loaded into the playback program and played back while superimposing a caption image and text.

FIG. 8 is a diagram of a caption script file according to an embodiment of the present invention. The present invention relates to a method of playing back a multimedia file in a multimedia playback program, in which a specific frame is selected based on the playback time axis of a multimedia file, one or more caption chapter markers 61, one or more caption pass markers 62, and one or more caption pause markers 63 on which time codes thereof are recorded are defined, the defined markers are stored in the metadata of the multimedia file, caption text and image data, such as JPG and PNG, are stored in the metadata of the same data, the multimedia file 50 connected to each of the marker frames is loaded into the playback program, the control means 34 detects each of the caption markers and performs control so that playback is performed while passing through the caption chapter marker 61, but playback is started from a relevant part, playback is performed while passing through the caption pass marker 62, but playback is started from a relevant part when the script file is rewound, and the caption image and the text are superimposed while temporally stopping playback at the caption pause marker 63.

The present invention relates to a method of playing back a multimedia file in a multimedia playback program, including the playback setting step 10 of setting and storing learning setting in the metadata region of a file, selecting a specific frame based on the playback time axis of the multimedia file, loading the multimedia file 50 in which several kinds of the markers 51, 52, 53, 54, and 55 are defined and stored in the metadata region of the multimedia file into the playback program, and setting the number of times of playbacks and a pause time in the setting means 33, for convenience of learning; the file playback step 12 of selecting and playing back the multimedia file 50; the pause step 13 of detecting the marker frames and passing through playback at what marker (the chapter marker 53), but staring playback from a relevant part, passing through playback at what marker (the pass marker 52), but starting playback from a relevant part when the multimedia file is rewound, skipping playback at what marker (the skip marker 54), but temporally stopping playback at what marker (the pause marker 51) according to learning setting set in the metadata region of a file played back by the control means 34; the playback switch manipulation step 14 of allowing a learner to directly answer a played sentence using the pause time or releasing the pause by manipulating the switch means 32 after completing studies, such as shadowing or a dictation; and the pause release step of releasing the pause key when the playback switch manipulation step 14 is not performed until a pause release time set in the setting means 33, wherein each marker studies a foreign language while performing a playback function according to learning setting set in the metadata region of a file and the markers 51, 52, 53, 54, and 55 may be differently set using several methods according to learning setting.

The present invention relates to a method of playing back a multimedia file in a multimedia playback program, in which the multimedia file 50 being played, from which a specific frame is selected based on the playback time axis of a multimedia file and in which the one or more chapter markers 53, the one or more pass markers 52, the one or more pause markers 51, and the one or more skip markers 54 on which time codes thereof are recorded are defined, and the markers are divided into role-playing A and B groups, the marker information is stored in the metadata region of the multimedia file is the multimedia file 50, and the learning settings of the role-playing A and B are added to the playback setting step 10. The method includes a function in which, when the multimedia file 50 is played, the audio signal of the role-playing A group marker is muted and the audio signal of the role-playing B group marker is played back according to an original volume, in the setting of the role-playing A, and the audio signal of the role-playing B group marker is muted and the audio signal of the role-playing A group marker is played back according to an original volume, in the setting of the role-playing B, according to a role-playing set by the setting means 33.

In the present invention, a desired sentence can be repeatedly played back and efficiently learnt even in the state where the number of times of playbacks is set to one time by default without separately setting the number of times of playbacks and a pause release time. For example, if a sentence is not understood after listening to the sentence when studying a multimedia file while playing back the multimedia file, when a previous marker switch is actuated, the control means detects a previous marker and repeatedly plays back the sentence from the first part of the sentence. Accordingly, the previous marker switch is actuated, and thus a learner can efficiently study the played sentence while repeatedly playing the played sentence until the learner understands the played sentence. If some of the sentence is known to the learner during hearing, the learner may skip a relevant sentence by actuating a next marker button and efficiently study the next sentence. The present invention relates to a method of playing back a multimedia file, in which wired and wireless remote controller switch means having previous marker and next marker switches are attached outside a computer so that a learner can easily listen to a learnt sentence again or skip the sentence using his hand or foot through the switch means 32. The wired remote controller may include an additional wired remote controller in which the previous marker switch and the next marker switch are mounted on the middle part of an earphone and a headphone, and the wireless remote controller may include a wireless remote controller using a remote controller using Bluetooth and a dedicated signal in addition to an infrared remote controller.

According to the present invention, in a multimedia playback program, in order to provide a more specialized learning function, an additional script file having the same name as the multimedia file 50 is produced by using the content production marker program of the present invention, or a specific frame is selected and the one or more pause markers 51, the one or more pass markers 52, the one or more chapter markers 53, and the one or more skip markers 54 on which on which time codes thereof are recorded are defined on the basis of the playback time axis of the multimedia file 50 by using a caption script file, such as *.lrc or *.smi, the markers are stored in the script file, and enclosed in the same folder as the multimedia file 50. When the learner 25 loads the multimedia file 50 into the playback program, the script file is also loaded into the playback program. When the number of times of playbacks and a pause release time are set in the setting means 33 in the playback setting step 10, for convenience of learning, and the multimedia file 50 is selected and played back, the control means 34 repeatedly plays back the multimedia file 50 between the pause markers 51 by the number of times of playbacks set in the setting means 33. When the control means 34 detects each of the marker frames recorded on the script file, the control means 34 performs playback by passing through the multimedia file at the chapter markers 53, but may start playback from a relevant part, performs playback by passing through the multimedia file in the pass marker 52, but may start playback from a relevant part when the multimedia file is rewound, skips playback in the skip marker 54, and temporally stops the playback of the multimedia file in the marker frame in the pause marker 51. The learner 25 directly answers a played sentence using the pause time or performs various studies, such as shadowing or a dictation, and completes the studies. After the learner 25 releases the pause by manipulating the switch means 32 and plays back the multimedia file again, if the learner 25 does not perform the playback switch manipulation step 14 until the pause release time set in the setting means 33, the pause is automatically released. The present invention relates to a method of playing back a multimedia file, in which as described above, the control means 34 detects several kinds of the markers stored in the script file and repeats the file playback step 12, the pause step 13, the switch manipulation step 14, and the pause release step 15 more professionally so that the learner can study a foreign language while sequentially playing back the multimedia file 50.

The present invention relates to a method of playing back a multimedia file in a multimedia playback program, further including the playback setting step 10 of selecting a specific frame from an additional script file having the same name as the multimedia file 50 on the basis of the playback time axis of the multimedia file 50, enclosing a script file in which the one or more pause markers 51, the one or more pass markers 52, the one or more chapter markers 53, the one or more skip markers 54, and the one or more variable markers 55 on which time codes thereof are recorded are defined, enclosing the scrip file in the same folder as the multimedia file 50, loading both the multimedia file 50 and the script file into the playback program, and setting the variable markers 55 in the setting means 33. Accordingly, when the learner 25 sets the variable marker 55 as the pause marker 51 using the setting means 33, the variable marker 55 is actuated as the pause marker 51. When the learner 25 sets the variable marker 55 as the skip marker 54, playback is skipped at the marker. When the learner 25 sets the variable markers 55 as invalidation, the marker does not perform any function, and the multimedia file 50 may be sequentially played back.

The present invention relates to a method of playing back a multimedia file in a multimedia playback program, in which a script file having the same name as a multimedia file is enclosed in the same folder, a specific frame is selected from the script file on the basis of the playback time axis of the multimedia file, the one or more pause markers 51 are defined and stored in the script file, caption marker frames of an image file, such as JPG or PNG, or caption text to be superimposed, are stored in the display means 31, the multimedia file 50 having the same name as the script file produced by storing the path and name of the image file to be associated with the caption marker in the script file together with text is loaded into the playback program, and the caption image and the text are played back while superimposing the caption image and the text.

FIG. 8 is a diagram of a caption script file according to an embodiment of the present invention. The present invention relates to a method of playing back a multimedia file in a multimedia playback program, in which a scrip file having the same name as a multimedia file is enclosed in the same folder, a specific frame is selected from the script file on the playback time axis of the multimedia file, the one or more caption chapter markers 61, the one or more caption pass markers 62, and the one or more pause markers 63 on which time codes thereof are recorded are defined in the script file, the script file into which text to be superimposed and associated with the markers is inserted into the script file or on which the path and name of the image file are recorded and the multimedia file 50 are loaded into the playback program, the control means 34 detects each of the caption marker frames recorded on the script file, performs playback by passing through the script file at the caption chapter marker 61, but may start playback from a relevant part, performs playback by passing through the script file at the caption pass marker 62, but may start playback from a relevant part when the script file is rewound, and superimposes and plays back the caption image and the text while temporally stopping the playback at the caption pause marker 63.

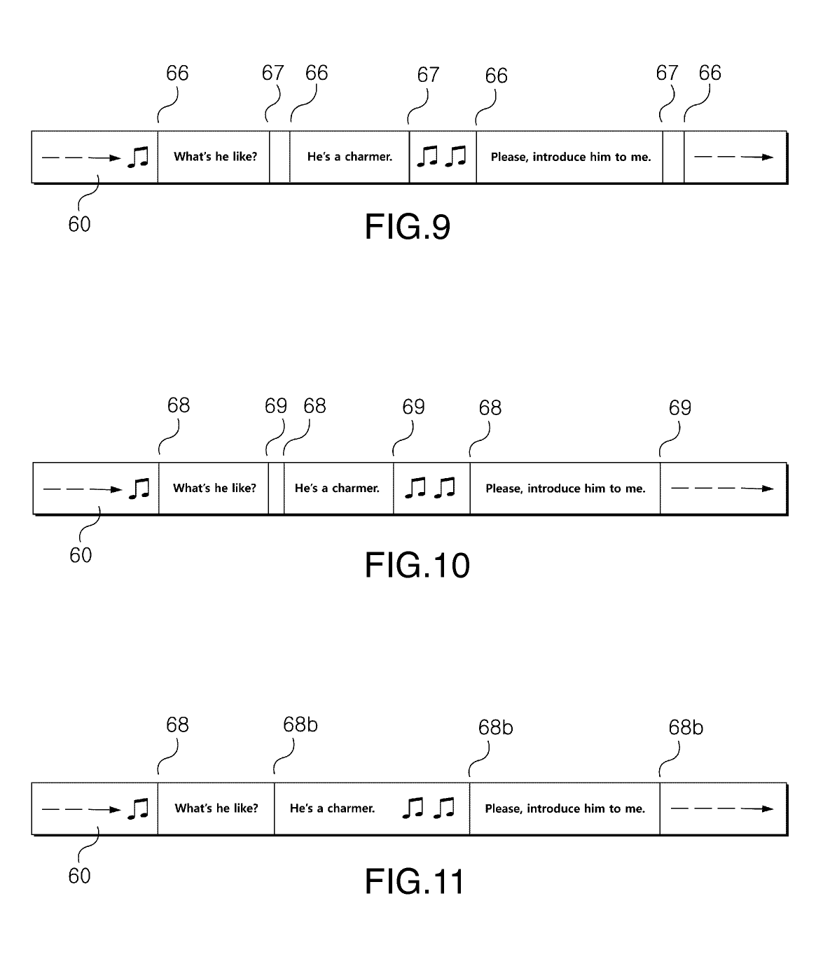

These days, a multimedia player or a playback program displays captions using a caption script file having the same name as a multimedia file when playing the multimedia file. If a caption script file having the same name as the multimedia file exists in the same folder in the multimedia player or the playback program, the multimedia player or the playback program is designed to play back an audio file or a video file and to display the caption text according to a caption in time code and a caption out time code recorded on the caption script file. The caption script file has the same file name as the multimedia file, but has a different extension from the multimedia file. An *.lrc caption script file is chiefly used as the caption script file in an MP3 file, and *.smi or *.srt files are chiefly used as the caption scrip file in an AVI file. The present invention relates to a method of playing back a multimedia file, in which the caption in time code and the caption out time code previously set in the caption script file 60 are detected, the multimedia file 50 is paused and played back again, and captions are displayed so that a foreign language can be learnt. FIG. 9 is a schematic diagram showing of the caption script file. The caption script file commonly includes caption in time tags 66, caption text, and caption out time tags 67. The caption text is formed of text including words of the characters, and a relevant caption is displayed in the caption in time and left at the caption out time. An example of the *.smi caption script file produced and used by Microsoft Inc. is as follows.

<SYNC Start=180300><P Class=ENCC>
What's he like?
<SYNC Start=300300><P Class=ENCC>&nbsp;
<SYNC Start=360100><P Class=ENCC>
He's a charmer.
<SYNC Start=480300><P Class=ENCC>&nbsp;
<SYNC Start=540200><P Class=ENCC>
Please, introduce him to me.
<SYNC Start=600300><P Class=ENCC>&nbsp;

The caption script file function to display a caption on the SYNC Start=000 seconds 000 hour of parentheses < > and make disappear a previous caption. Furthermore, ‘&nbsp;’ is an html blank tag and a caption tag where not letter displays. The caption tag using the blank tag makes a previous caption disappear at a relevant time code and displays a blank caption. Consequently, the caption tag uses the blank tag as the caption out time tag. The present invention relates to a method of playing back a multimedia program file, in which a played file is the caption script file 60, having the caption in time tags 66 and the caption out time tags 67 recorded thereon and having the same name as the multimedia file 50, a learner loads the two files stored in an information storage medium into the playback program, and the number of times of playbacks and a pause release time are set in the setting means 33 in the playback setting step 10, for convenience of learning. When the learner selects and plays back the multimedia file, the control means 34 detects the time codes of the caption in time tags 66 and the caption out time tags 67 of the caption script file by the number of times of playbacks set in the setting means 33 and repeatedly plays back the multimedia file between the relevant frames of the multimedia file 50. Furthermore, the control means 34 performs playback by passing through the multimedia file at the frame of the caption in time tag 66, but starts playback from a relevant part when the multimedia file is repeatedly played back, and temporally stops the playback of the multimedia file 50 at the caption out time tag 67. When a learner performs studies, such as shadowing and a dictation, using the pause time, completes the studies, releases the pause by manipulating the switch means 32, and plays back the multimedia file again, and does not perform the playback switch manipulation step 14 until a setting release time previously set in the setting means 33, the pause is automatically released. The present invention, as described above, relates to a method of playing back a multimedia file, in which the control means 34 detects the caption in time tag 66 of the caption script file 60 and the time code of the caption out time tag 67, plays back the multimedia file 50, temporally stops the multimedia file 50, and sequentially plays back the multimedia file 50 by repeating the pause release step 15. It is to be noted that not only the *.smi caption script file, but also a caption script file including the caption in time tag 66 and the caption out time tag 67 of different forms may also be applied to the present invention.

These days, an MP3 file chiefly used to play audio displays a caption by using an *.lrc caption script file. The *.lrc caption script file uses a method of displaying caption text by using only one kind of the caption time tag 68 and making a previous caption disappear. An example of the *.lrc caption script file is as follows.

[00:03.30] What's he like?

[00:06.10] He's a charmer.

[00:09.20] Please, introduce him to me.

It can be seen that the caption script file includes a caption time code inserted within parentheses [ ] and caption text is displayed behind [ ] parentheses. The caption script file uses a simple method of displaying a caption in the time code of the caption time tag and making a previous caption disappear. However, the method is disadvantageous in that when a caption becomes in and out using one kind of the caption time tag as described above, a previous caption continues to be displayed until a next caption is displayed in a part followed by music, a soundless part, etc. in the middle of speech. In order to obviate the disadvantage, a blank character string caption time tag 69 may be inserted and used as the caption out time tag.

[00:03.30] What's he like?

[00:05.30]

[00:06.10] He's a charmer.

[00:07.30]

[00:09.20] Please, introduce him to me.

[00:10.30]

‘[00:05.30]’ ‘[00:07.30]’ ‘[00:10.30]’ in the blank character string caption out time tag 69 is not seed by an eye because it is a blank character in the sample sentence, but a blank character ‘ ’ is produced behind the parentheses [ ] by pressing the space bar. Thus, when a blank character caption appears in a time code thereof, a previous caption disappears. The blank character string caption time tag 69 may be used as the caption out time tag. The present invention relates to method of playing back a multimedia program file, in which the caption script file 60 displaying a caption by using only one kind of the caption time tag 68. The multimedia file 50 having the same name as a caption script file, produced by inserting the caption time tag 68 into a part where speech is started and inserting the blank character string caption time tag 69, having only a blank character string, into a part where speech is ended or a caption disappears because music is generated, is loaded into the program. The present invention relates to method of playing back a multimedia program file, in which the control means 34 repeatedly plays back the multimedia file between two caption time codes by the number of times of playbacks set in the setting means 33 by detecting the time codes of the caption time tag 68 and the blank character string caption time tag 69. Furthermore, the control means 34 performs playback by passing through the multimedia file at the frame of the caption time tag 68, but starts playback from a relevant part at the time of repetitive play back, temporally stops the playback of the multimedia file at the blank character string caption time tag 69, sequentially plays back the multimedia file, and displays a caption.

FIG. 11 is a diagram of a caption script file 60 according to an embodiment of the present invention. The present invention relates to a method of playing back a multimedia program file, in which in using the caption script file 60 for displaying a caption and making a previous caption disappear by using only one kind of the caption time tag 68, the control means 34 performs control so that the multimedia file between two front and rear caption time tags is repeatedly played back by the number of times of playbacks set in the setting means 33 by detecting by detecting the time codes of the caption time tags 68. Furthermore, the present invention relates to a method of playing back a multimedia program file the control means 34 performs playback by passing through the multimedia file at the frame of the caption time tag 68 first started, but when the multimedia file is repeatedly played back, starts playback from a relevant part, temporally stops the playback of the multimedia file at the consecutive caption time tag 68b, and sequentially plays back the multimedia file. The multimedia file 50 may be sequentially played back by using the caption time tag 68, the consecutive caption time tag 68b, and the blank character string caption time tag 69 together. The control means 34 performs playback by passing through the multimedia file at the frame of the caption time tag 68 first started when the caption time tag 68 is overlapped, but when the multimedia file is repeatedly played back, starts playback from a relevant part, temporally stops the playback of the multimedia file in the frames of the consecutive caption time tag 68b and the blank character string caption time tag 68b, and effectively sequentially plays back the multimedia file.

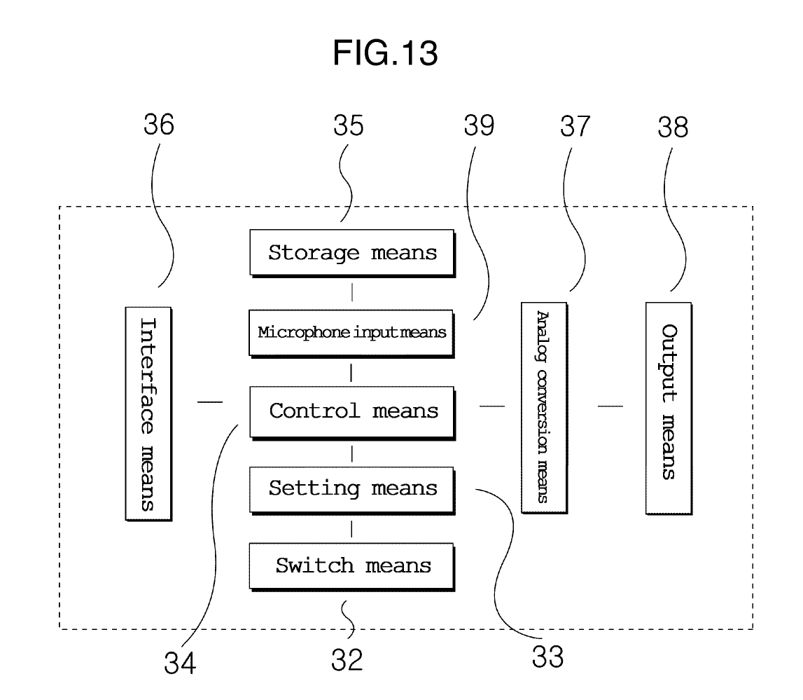

FIG. 13 shows the construction of the multimedia player 30 according to an embodiment of the present invention. In the multimedia player of the present invention, the learner 25 stores the one or more multimedia files 50B in file storage means 35 through interface means 36, loads the multimedia files 50B into the multimedia player, selects the multimedia file by manipulating the switch means 32, and plays back the selected multimedia file. When the control means 34 detects the end part of the multimedia file 59 while playing back the file, the control means 34 temporally stops the playback at the relevant frame. When the learner 25 directly answers a played sentence or performs various studies, such as follow or a dictation, using a pause time and releases the pause key by manipulating the switch means 32, next files are sequentially played back. As described above, a file is selected and played back using the switch means 32, the pause key is released, and the control means 34 temporally stops the playback of the multimedia file and plays back the multimedia file again. Furthermore, various settins are performed using the setting means 33, the multimedia file is stored in the storage means 35, analog conversion means 37 converts decoded audio and video signals, the display means 31 displays states operated by key manipulation, video, and text, output means 38 outputs the audio signal, and the interface means 36 transmits and receives data to and from a computer. One or more multimedia files stored in a folder are sequentially played back, and a foreign language is learnt.

In the multimedia player 30 of the present invention, the setting means 33 sets the number of times of playbacks and a pause release time, for convenience of learning, and the multimedia file 50B is selected and played back by manipulating the switch means 32. The control means 34 plays back the multimedia file by the number of times of playbacks set in the setting means 33, detects the end part of the multimedia file 59, and temporally stops the playback at a relevant frame. If the learner 25 directly answers a played sentence or completes various studies, such as shadowing or a dictation, by using the pause time and releases the pause key by manipulating the switch means 32 or does not manipulate the file playback switch means 32 until the pause release time set in the setting means 33, a next file is sequentially played back.

In the multimedia player of the present invention, when the control means 34 plays a file and detects a soundless part for some time or more in the audio signal of the file, the control means 34 temporally stops playback at a relevant frame. If the learner 25 directly answers a played sentence by using the pause time or completes various studies, such as shadowing or a dictation, and releases the pause key by manipulating the switch means 32, the file is played back again. Even in the present invention, for convenience of learning, the number of times of playbacks and a pause release time may be set in the setting means 33, and the file may be repeatedly played back by the number of times of playbacks. After a lapse of the pause release time, the pause may be automatically released and the file may be sequentially played back.

FIG. 4 is a diagram showing the multimedia file 50 according to an embodiment of the present invention. In the multimedia player 30 of the present invention, the multimedia file 50 in which the one or more pause markers 51 are defined in the metadata region of the multimedia file 50 by using the content production marker program of the present invention is stored in the file storage means 35 through the interface means 36, loaded into the multimedia player 30, selected by manipulating the switch means 32, and then played back. When the control means 34 detects the pause marker 51 while playing back the multimedia file 50, the control means 34 temporally stops the playback at a relevant frame. If the learner 25 directly answers a played sentence by using the pause time or completes various studies, such as shadowing or a dictation, and releases the pause key by manipulating the switch means 32, the file is played back again. As described above, the multimedia file is selected and played back by the switch means 32, the pause key is released, and the control means 34 temporally stops the playback of the multimedia file and plays back the multimedia file again. Furthermore, various settings are set by the setting means 33, the multimedia file is stored in the storage means 35, the analog conversion means 37 converts decoded audio and video signals, the display means 31 displays states operated by the key manipulation, video, and text, the output means 38 outputs an audio signal, and the interface means 36 transmits and receives data to and from a computer. Accordingly, a foreign language can be learnt while sequentially playing back the multimedia file 50.

In the multimedia player 30 of the present invention, a played file is the multimedia file 50 on which the one or more pause markers 51 are defined in the metadata region of the multimedia file. The setting means 33 sets the number of times of playbacks and a pause release time, and the multimedia file is played back by the set number of times of playbacks. If the learner 25 does not manipulate the file playback switch means 32 until the set pause release time, the multimedia file is sequentially played back, and the learner studies a foreign language.

FIG. 5 is a diagram showing a multimedia file according to an embodiment of the present invention. In the multimedia player 30, in order to provide a more specialized learning function, a specific frame is selected on the basis of the playback time axis of the multimedia file, the one or more pause markers 51, the one or more pass markers 52, the one or more chapter markers 53, and the one or more skip markers 54 on which time codes thereof are recorded are defined by using the content production marker program of the present invention and stored in the metadata region of the multimedia file, and the multimedia file is stored again. The learner 25 stores the multimedia file 50 in the file storage means 35 through the interface means 36 and loads the multimedia file 50 into the multimedia player. For convenience of learning, the learner 25 sets the number of times of playbacks and a pause release time in the setting means 33, selects the multimedia file 50 by manipulating the switch means 32, and plays back the multimedia file 50. When the control means 34 plays back the multimedia file 50 by the number of times of playbacks set in the setting means 33 and detects each of the markers, the control means 34 performs playback by passing through the multimedia file at the chapter marker 53, but may start the playback from a relevant part, performs playback by passing through the multimedia file in the pass marker 52, but may start the playback from a relevant part when the multimedia file is rewound, skips the playback in the skip marker 54, and temporally stops the playback at the frame of the pause marker 51. If the learner 25 directly answers a played sentence by using the pause time or completes various studies, such as shadowing or a dictation, and then releases the pause key by manipulating the switch means 32 or does not manipulate the file playback switch means 32 until the pause release time set in the setting means 33, the multimedia file is played back again. The multimedia file is not paused at a relevant marker because the pass marker 52 of the title part English audio 20 of FIG. 5 is a title part, but when the learner learns a next part English audio 21 and tries to play the multimedia file or repeatedly plays back the multimedia file, the multimedia file is played back from the first part of the sentence. The chapter marker 53 enables a desired chapter to be easily retrieved and played back.

The present invention relates to the multimedia player in which when specific voice, such as ‘Next’ or ‘ [symbol] ’, is spoken in the pause state, the microphone input means 39 detects the voice signal and the control means 34 releases the pause key.

The present invention relates to the multimedia player in which if no voice signal is not detected by the microphone input means 39 after voice, such as an answer, a composition, and interpretation, is generated for some time in the pause state, the control means 34 releases the pause key.

The present invention relates to the multimedia player in which the learner 25 has repeatedly learnt words or a sentence several times, changes the pause markers 51 of the words and the sentence for which studies have been completed into the skip markers 54 by using the switch means 32, and after the studies, stores them in the metadata region of the multimedia file, and then stores the multimedia file again. Efficient learning can be performed because the changed skip markers 54 are not played back in next studies.

The present invention relates to the multimedia player in which a specific frame is selected the playback time axis of a multimedia file, the one or more chapter markers 53, the one or more pass markers 52, the one or more pause markers 51, and the one or more skip markers 54 on which time codes thereof are recorded are defined and stored in the multimedia file 50, the multimedia file 50 stored in the metadata of the multimedia file, together with the multimedia file 50B without a marker, are loaded into the multimedia player, and the control means 34 detects each of the markers, performs playback by passing through the multimedia file at the chapter markers 53, but may start the playback from a relevant part, performs playback by passing through the multimedia file in the pass markers 52, but may start the playback from a relevant part when the multimedia file is rewound, temporally stops the playback in the pause markers 51, skips the playback in the skip markers 54, passes through the start part 58 of the multimedia file like the chapter markers 53 when sequentially playing back the multimedia file 50B without a marker, but may start the playback from a relevant part, and temporally stops the end part of the multimedia file 59 like the pause marker 51.

The present invention relates to the multimedia player in which a specific frame is selected the playback time axis of a multimedia file, the one or more chapter markers 53, the one or more pass markers 52, the one or more pause markers 51, and the one or more skip markers 54 on which time codes thereof are recorded are defined and stored in the multimedia file 50, all the files of a folder in which the multimedia file 50 stored in the metadata of the multimedia file and the multimedia file 50B without a marker are stored are loaded into the multimedia player, the start parts 58 of the chapter markers 53 and the multimedia file 50B without a marker are listed up in the same name to produce the playback list 70, and the control means 34 detects each of the markers, performs playback by passing through the multimedia file at the chapter markers 53, but may start the playback from a relevant part, performs playback by passing through the multimedia file in the pass markers 52, but may start the playback from a relevant part when the multimedia file is rewound, temporally stops the playback in the pause markers 51, skips the playback in the skip markers 54, passes through the start part 58 of the multimedia file like the chapter markers 53 when sequentially playing back the multimedia file, but may start the playback from a relevant part, and always temporally stops the end part of the multimedia file 59 like the pause marker 51.

The present invention relates to the multimedia player in which a specific frame is selected the playback time axis of a multimedia file, the one or more chapter markers 53, the one or more pass markers 52, the one or more pause markers 51, and the one or more skip markers 54 on which time codes thereof are recorded are defined and stored in the multimedia file 50, the multimedia file 50 stored in the metadata of the multimedia file and a multimedia file without a marker are randomly mixed and loaded into the multimedia player, and the markers and the multimedia file without a marker are randomly played back.

The present invention relates to the multimedia player in which when a part under a playback screen is selected in a file playback state, the thumbnail images of the chapter markers are small displayed. When a learner selects a desired thumbnail, control is performed so that playback is started from the chapter marker. Furthermore, gauge bars indicating the respective markers are displayed in a playback scroll bar with different colors and thicknesses. For example, the chapter marker may be displayed with a thicker gauge bar and other markers may be displayed with thinner gauge bars with different colors so that a learner can easily identify each chapter and each marker. When a learner selects the gauge bar of a desired marker, control is performed so that playback is started from a relevant marker. As described above, the present invention relates to the multimedia player, in which the chapter markers and the markers are displayed with the thumbnails and the gauge bars, and a marker where a multimedia file is selected is immediately played back and effectively sequentially played back.

The present invention relates to the multimedia player, including a function of selecting a specific frame on the basis of the playback time axis of a multimedia file, defining the one or more pause markers 51, the one or more pass markers 52, the one or more chapter markers 53, the one or more skip markers 54, and the one or more variable markers 55 on which time codes thereof are recorded and storing them in the multimedia file 50, loading the multimedia file 50 stored in the metadata region of the multimedia file into the multimedia player, and setting the variable markers 55 in the setting means 33. When the learner 25 sets the variable marker 55 as the pause marker 51 in the setting means 33, the variable marker 55 is operated as the pause marker 51. When the variable marker 55 is set as the skip marker 54, playback is skipped at the marker. When the variable marker 55 is set as invalidation, the marker does not perform any function.

In the multimedia player of the present invention, when the control means 34 repeatedly performs playback between the pause markers 51 by the number of times of playbacks set in the setting means 33, if there is a high audio signal close to the pause marker 51, the audio may be suddenly played back loudly. In order to prevent the sudden loud playback of the audio, the present invention relates to the multimedia player in which a circuit for fading in a start audio signal when a file is repeatedly played back and for fading out an end part audio when a file is paused is added to the control means 34.

In the multimedia player of the present invention, the control means 34 repeatedly performs playback between markers by the number of times of playbacks and a pause release time set in a multimedia file and performs playback by catching a marker frame so that the caption of a marker appears when the multimedia file is paused in the pause marker 51 for more efficient learning. If a multimedia player is not precisely operated in unit of ±0 frames, however, the caption of a front marker may appear in its start part when playback is repeatedly performed. In order to prevent the phenomenon in which the caption of the former marker unnecessarily appears, the multimedia player further includes a function of starting playback from a specific frame at the rear part of a marker when playback is repeatedly performed is added.

The multimedia player of the present invention includes a function of repeatedly performing playback without a pause time in the number of times of playbacks in the front part and temporally stopping the playback by a pause time only in the number of times of playbacks at the last part for efficient repetitive listening and learning, when the control means 34 repeatedly performs playback between the pause markers 51 by the number of times of playbacks set in a multimedia file.

In the multimedia player of the present invention, a specific frame is selected based on the playback time axis of a multimedia file, one or more pause markers 51 on which time code thereof are recorded are defined and stored in the metadata region of the multimedia file, the specific frame is selected from the metadata region of the same file name on the basis of the playback time axis of the multimedia file, one or more caption markers are captured, and the multimedia file 50 in which image data, such as JPG and PNG, or text is stored in the metadata region of the multimedia file is loaded into the multimedia player and played back while superimposing a caption image and the text.

The present invention relates to the multimedia player in which a specific frame is selected based on the playback time axis of a multimedia file, the one or more caption chapter markers 61, the one or more caption pass markers 62, and the one or more caption pause markers 63 on which time codes thereof are recorded are defined and stored in the metadata of the multimedia file, caption text and image data, such as JPG and PNG, are stored in the metadata of the same data, the multimedia file 50 connected to each of the marker frames is loaded into the multimedia player, the control means 34 detects each of the caption markers and performs control so that playback is performed while passing through the caption chapter marker 61, but playback is started from a relevant part, playback is performed while passing through the caption pass marker 62, but playback is started from a relevant part when the script file is rewound, and the caption image and the text are superimposed while temporally stopping playback at the caption pause marker 63.

The present invention relates to the multimedia player in which learning setting is defined in the metadata region of a multimedia file, a specific frame is selected based on the playback time axis of the multimedia file, the multimedia file 50 in which several kinds of the markers 51, 52, 53, 54, and 55 are defined and stored in the metadata region of the multimedia file into the multimedia player, the number of times of playbacks and a pause time are set in the setting means 33, each of the marker frames is detected according to learning setting set in the metadata region of a file played back, playback is passed through what marker (the chapter marker 53), but playback may be started from a relevant part, playback is passed through what marker (the pass marker 52), but playback may be started from a relevant part when the multimedia file is rewound, playback is skipped at what marker (the skip marker 54), but the playback is paused at what marker (the pause marker 51) so that a foreign language can be leant.

The present invention relates to the multimedia player in which the multimedia file 50 being played, from which a specific frame is selected based on the playback time axis of a multimedia file and in which the one or more chapter markers 53, the one or more pass markers 52, the one or more pause markers 51, and the one or more skip markers 54 on which time codes thereof are recorded are defined, the markers are divided into role-playing A and B groups, the marker information is stored in the metadata region of the multimedia file is the multimedia file 50, and the learning settings of the role-playing A and B are added to the playback setting means 33. The multimedia player includes a function in which, when the multimedia file 50 is played, the audio signal of the role-playing A group marker is muted and the audio signal of the role-playing B group marker is played back according to an original volume, in the setting of the role-playing A, and the audio signal of the role-playing B group marker is muted and the audio signal of the role-playing A group marker is played back according to an original volume, in the setting of the role-playing B, according to the role-playing setting in the setting means 33.

The multimedia player of the present invention further includes wired and wireless remote controller switch means having a previous marker switch and a next marker switch so that a learner can conveniently listen to or skip a studied sentence or words when the learner puts the multimedia player in his bag and studies while listening using an earphone, in addition to the multimedia player. The wired remote controller may include an additional wired remote controller in which the previous marker switch and the next marker switch are mounted on the middle part of an earphone and a headphone, and the wireless remote controller may include a wireless remote controller using a remote controller using Bluetooth and a dedicated signal in addition to an infrared remote controller.

The present invention relates to the multimedia player 30 in which all the parts of the display means 31 are set in the playback switch means 32 so that all the parts can be manipulated by the touch panel playback switch in order for a learner can conveniently release the file pause 13 without erroneous manipulation.

The present invention relates to the multimedia player 30 in which an additional script file having the same name as the multimedia file 50 is defined and produced by using the content production marker program of the present invention or a caption script file, such as *.lrc or *.smi, is enclosed in the same folder, a specific frame is selected on the basis of the playback time axis of the multimedia file 50, the one or more pause markers 51 on which time codes thereof are recorded are defined and stored in the script file, and the script file, together with the multimedia file 50, is stored in the file storage means 35 through he interface means 36. When the learner 25 loads the multimedia file 50 into the multimedia player, the script file is also loaded. The learner 25 selects and plays back the multimedia file 50 by manipulating the switch means 32. When the control means 34 detects the pause marker 51 recorded on the script file while playing back the multimedia file 50, he control means 34 temporally stops the playback at a relevant frame. After the learner 25 directly answers a played sentence or performs various studies, such as follow or a dictation, by using a pause time, the learner 25 releases the pause key by manipulating the switch means 32, the file is played back again.

In the multimedia player 30 of the present invention, the multimedia file 50 being played includes an additional script file having the same name as the multimedia file is defined, a caption script file, such as *.lrc or *.smi, is enclosed in the same folder, a specific frame is selected on the basis of the playback time axis of the multimedia file 50, and the one or more pause markers 51 on which time codes thereof are recorded are defined and stored in therein. The number of times of playbacks and a pause release time are set in the setting means 33, and the control means 34 plays back the multimedia file by the number of times of playbacks set in the setting means 33 and plays back the multimedia file if the learner 25 does not manipulate the playback switch means 32 until the pause release time set in the setting means 33.

The present invention relates to the multimedia player 30 in which an additional script file having the same name as the multimedia file 50 is defined and produced by using the content production marker program of the present invention or a caption script file, such as *.lrc or *.smi, is enclosed in the same folder, a specific frame is selected on the basis of the playback time axis of the multimedia file 50, and the one or more pause markers 51, the one or more pass markers 52, the one or more chapter markers 53, and the one or more skip markers 54 on which time codes thereof are recorded are defined and stored in the script file. The script file, together with the multimedia file 50, is stored in the file storage means 35 through the interface means 36. When the learner 25 loads the multimedia file 50 into the multimedia player, the script file is also loaded. For convenience of learning, the learner 25 sets the number of times of playbacks and a pause release time in the setting means 33 and selects and plays back the multimedia file 50 by manipulating the switch means 32. When the control means 34 detects each of the markers recorded on the script file while playing back the multimedia file 50 by the number of times of playbacks set in the setting means 33, the control means 34 performs the playback by passing through the multimedia file at the chapter marker 53, but may start the playback from a relevant part, performs the playback by passing through the multimedia file in the pass marker 52, but may start the playback from a relevant part when the multimedia file is rewound, skips the playback in the skip marker 54, and temporally stops the playback in the pause marker 51. After the learner 25 directly answers a played sentence or completes various studies, such as follow or a dictation, by using the pause time, the learner 25 releases the pause key by manipulating the switch means 32 or does not manipulate the file playback switch means 32 until the pause release time set in the setting means 33, the multimedia file is played back again.

The present invention relates to the multimedia player in which the multimedia file 50 is a file in which an additional script file having the same name as the multimedia file is produced and stored, a specific frame is selected from the additional script file on the basis of the playback time axis of the multimedia file 50, the script file in which the one or more pause markers 51, the one or more pass markers 52, the one or more chapter markers 53, the one or more skip markers 54, and the one or more variable markers 55 on which time codes thereof are recorded are defined is enclosed in the same folder as the multimedia file 50, and a function of loading both the multimedia file 50 and the script file into the multimedia player and setting the variable markers 55 in the setting means 33 is added. Accordingly, when the learner 25 sets the variable marker 55 as the pause marker 51 using the setting means 33, the variable marker 55 is actuated as the pause marker 51. When the learner 25 sets the variable marker 55 as the skip marker 54, playback is skipped at the marker. When the learner 25 sets the variable markers 55 as invalidation, the marker does not perform any function, and the multimedia file 50 may be sequentially played back.

The present invention relates to the multimedia player in which a scrip file having the same name as a multimedia file is enclosed in the same folder, a specific frame is selected from the script file on the basis of the playback time axis of the multimedia file, the one or more pause markers 51 on which time codes thereof are defined are stored in the script file, caption marker frames of an image file, such as JPG or PNG, or caption text to be superimposed, are stored in the display means 31, the multimedia file 50 having the same name as the script file produced by storing the path and name of the image file to be associated with the caption markers in the script file, together with text, is loaded into the multimedia player, and the caption image and the text are played back while superimposing the caption image and the text.

The present invention relates to the multimedia player in which a scrip file having the same name as a multimedia file is enclosed in the same folder, a specific frame is selected on the basis of the playback time axis of a multimedia file and stored in the script file, the one or more caption chapter markers 61, the one or more caption pass markers 62, and the one or more pause markers 63 on which time codes thereof are recorded are stored in the script file, the script file into which text to be superimposed in association with the markers has been inserted or on which the path and name of the image file are recorded and the multimedia file 50 are loaded into the multimedia player, the control means 34 detects each of the caption marker frames of the script file, performs playback by passing through the multimedia file at the caption chapter marker 61, but may start the playback at the part, performs playback by passing through the multimedia file at the caption pass marker 62, but starts the playback from a relevant part when the multimedia file is rewound, and temporally stops the playback at the caption pause marker 63. The switch means 32 directly answers a played sentence by using the pause time or completes studies, such as shadowing or a dictation, and then releases the pause. If the playback switch means 32 is not executed until the pause release time set in the setting means 33 in the pause state, the pause key is released, and the caption image and the text is played back while superimposing them.

In the multimedia player of the present invention, a played file is the caption script file 60 having the same name as the multimedia file 50. The caption in time tag 66 and the caption out time tag 67 are stored in the caption script file. When the two files are stored in the file storage means 35 through the interface means 36 and the multimedia file 50 is loaded into the multimedia player, the caption script file 60 is also loaded. When a learner sets the number of times of playbacks and a pause release time in the setting means 33 for convenience of learning and selects and plays back the multimedia file 50 by using the playback switch means 32, the control means 34 detects the time codes of the caption in time tag 66 and the caption out time tag 67 of the caption script file 60 and repeatedly plays back the multimedia file 50 between the relevant frames by the number of times of playbacks set in the setting means. Furthermore, the control means 34 performs playback by passing through the multimedia file in the frames of the caption in time tag 66, but performs control so that the playback is started from a relevant part when the multimedia file is repeatedly played back, and temporally stops the playback of the multimedia file 50 in the frames of the caption out time tag 67. When a learner completes studies, such as a dictation and shadowing, in the pause state the learner and executes the playback switch means 32, the pause is released and the multimedia file is played back again. Furthermore, if the learner does not execute the playback switch means 32 until the pause release time set in the setting means 33 in the pause state, the control means 34 automatically releases the pause. As described above, the present invention relates to the multimedia player in which the multimedia file 50 is sequentially played back and captions are displayed by using caption in and out-time codes previously produced in the caption script file 60.

FIG. 10 is a diagram showing the caption script file 60 according to an embodiment of the present invention. The present invention relates to the multimedia player using the caption script file 60 for displaying captions by using only one kind of the caption time tag 68. A caption script file, produced by inserting the caption time tag 68 into a part where speech is started and inserting the blank character string caption time tag 69, having only a blank character string, into a part where the speech is ended or a part from which captions preferably disappear because music is generated is loaded into the multimedia player. The control means 34 detects the time codes of the caption time tag 68 and the blank character string caption time tag 69 and repeatedly plays back the multimedia file between the two caption time codes by the number of times of playbacks set in the setting means 33. Furthermore, the control means 34 performs playback by passing through the multimedia file at the frame of the caption time tag 68, but starts the playback from a relevant part when the multimedia file is repeatedly played back, temporally stops the playback of the multimedia file at the blank character string caption time tag 69, sequentially plays back the multimedia file, and displays a caption.

FIG. 11 is a diagram showing the caption script file 60 according to an embodiment of the present invention. The present invention relates to the multimedia player using the caption script file 60 for displaying a caption and excluding a previous caption by using only one kind of the caption time tag 68. The control means 34 detects the time code of the caption time tag 68 and performs control so that the multimedia file between the two front and rear caption time tags is repeatedly played back by the number of times of playbacks set in the setting means 33. Furthermore, the control means 34 of the multimedia player performs playback by passing through the multimedia file at the frame of the caption time tag 68 first started, but starts the playback from a relevant part when the multimedia file is repeatedly played back, temporally stops the playback of the multimedia file at the consecutive caption time tags 68b, and sequentially played back the multimedia file. The multimedia file 50 may be sequentially played back by using the caption time tags 68, the consecutive caption time tags 68b, and the blank character string caption time tags 69 together. The control means 34 may perform playback by passing through the multimedia file at the frame of the caption time tag 68 first started when the caption time tag 68 is redundant, but start the playback from a relevant part when the multimedia file is repeatedly played back, pause the playback of the multimedia file in the frames of the consecutive caption time tags 68b and the blank character string caption time tags 68b, and effectively sequentially play back the multimedia file.

The present invention relates to the multimedia player in which the caption script file 60 loaded along with the multimedia file 50 is parsed, and the time code of the caption in time tag 66 is defined as the pass marker 52 and the time code of the caption out time tag 67 is defined as the pause marker 51 and then stored in the metadata region of the multimedia file 50. In relation to the pass markers 54 and the pause markers 51 stored as described above, the control means 34 of the multimedia player and the multimedia playback program performs playback by passing through the multimedia file in the frames of the pass markers 52, but starts the playback from a relevant part when the multimedia file is repeatedly played back, temporally stops the playback of the multimedia file 50 in the pause markers 51, and effectively sequentially plays back the multimedia file.

The present invention relates to a multimedia disk player, such as a DVD player. A specific frame is selected on the basis of the playback time axis of a disk track, and a disk in which the one or more pause markers 51 on which time codes thereof are recorded are defined and stored in the information region of the disk is loaded into the multimedia disk player. The multimedia disk player includes the setting means 33 for setting the number of times of playbacks and a pause time for convenience of learning, the switch means 32 for selecting and playing the tracks of the disk, the control means 34 for detecting the pause markers 51 and temporally stopping playback at the frame, the playback switch means 32 for directly answering a played sentence or completes studies, such as shadowing or a dictation, by using the pause time and then releases the pause, the control means 34 for releasing the pause of the disk if the playback switch means 32 is not executed until the pause release time set in the setting means 33 in the pause state, the display means 31 for displaying states operated by the control means 34 for playing back the disk and temporally stopping the playback, the switch means 32 for releasing the pause of video, the control means 34, the analog conversion means 37 for converting decoded video and an audio signal, and key manipulation, and the output means 38 for outputting the video and the audio signal. Accordingly, a foreign language can be learnt while sequentially playing back the disk. The multimedia disk player may also be used in not only a DVD player, but also a multimedia disk player using other disks, such as a CD player and a Blu-ray player. Furthermore, a disk can be repeatedly played back and paused by the control means 34 by using the chapter markers chapter markers of the existing disk as the pause markers of the present invention.

The present invention relates to a multimedia disk player, such as a DVD player, in which a specific frame is selected on the basis of the playback time axis of a disk track, a disk in which the one or more chapter markers 53, the one or more pass markers 52, the one or more pause markers 51, and the one or more skip markers 54 on which time codes thereof are recorded are defined and stored in the information region of the disk, and the disk is loaded into the multimedia player. The multimedia disk player includes the setting means 33 for setting the number of times of playbacks and a pause time for convenience of learning, the switch means 32 for selecting and playing back the disk, the control means 34 for performing control so that playback is passed in the chapter markers 53, but the playback is started, playback is passed the pass markers 52, but playback is started from a relevant part when the disk is rewound, the playback of the disk is skipped in the skip markers 54, and the playback is paused in the pause markers 51, the playback switch means 32 for directly answering a played sentence or completes studies, such as shadowing or a dictation, by using the pause time and then releases the pause, the control means 34 for releasing the pause of the disk if the playback switch means 32 is not executed until the pause release time set in the setting means 33 in the pause state, the display means 31 for displaying states operated by the control means 34 for playing back the disk and temporally stopping the playback, the switch means 32 for releasing the pause of video, the control means 34, the analog conversion means 37 for converting decoded video and an audio signal, and key manipulation, and the output means 38 for outputting the video and the audio signal.

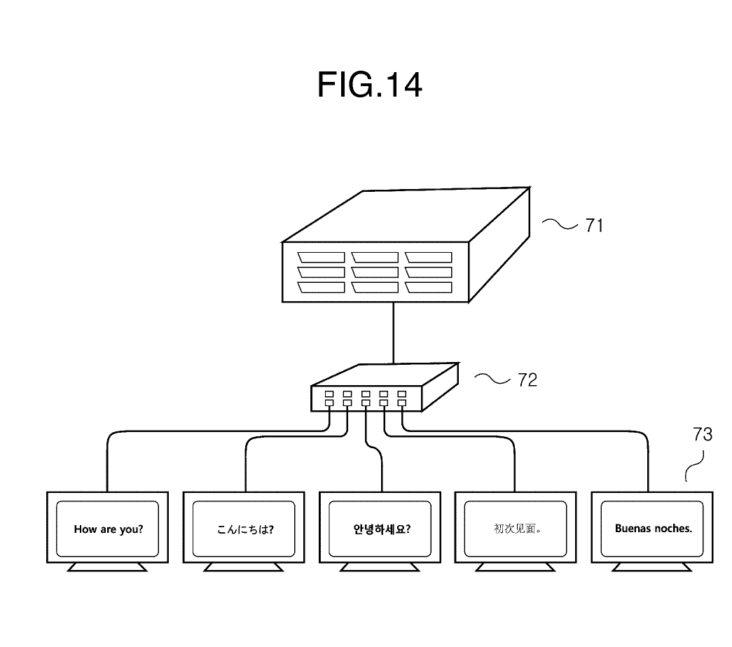

FIG. 14 is a schematic flowchart illustrating an embodiment of the present invention. The present invention relates to a multimedia Video On Demand (VOD) system. The multimedia file 50 being played is the multimedia file 50 in which a specific frame is selected on the basis of the playback time axis of the multimedia file and the one or more pause markers 51, the one or more pass markers 52, the one or more chapter markers 53, and the one or more skip markers 54 on which time codes thereof are recorded are defined are stored in the metadata region of the multimedia file. The multimedia is stored in the file storage means 35 of a VOD server 61, one or more client terminals 63 are coupled to the VOD server 61 over a network 62, and the client terminal 63 selects the multimedia file stored in the VOD server 61 and loads the selected multimedia file. The multimedia VOD system includes the setting means 33 for setting the number of times of playbacks and a pause release time in the client terminal 63 for convenience of learning, the playback switch means 32 of the client terminal 63 for selecting and playing back the multimedia file 50 or releasing the pause after completing studies in the pause state, the control means 34 of the VOD server 61 for playing back the multimedia file by the set number of times of playbacks, detecting each of the marker frames, and performing control so that playback is performed at the chapter markers 53 by passing through the multimedia file, but playback is started from a relevant part, playback is performed by passing through the multimedia file in the pass markers 52, but playback is started from a relevant part when the multimedia file is rewound, playback is skipped in the skip markers 54, but the playback of the multimedia file is paused in the pause markers 51, and the pause key is automatically released and a series of signals are controlled if the playback switch means 32 is not executed until the pause release time set in the setting means 33 in the pause state, the analog conversion means 37 for converting decoded audio and video signals, the display means 31 for displaying states operated by key manipulation and video and text, and the output means 38 for outputting the audio signals. The one or more client terminals 63 coupled to the VOD server 61 sequentially play back the multimedia files so that a foreign language can be learnt. The client terminal may also be used as a set-top box and a computer as well as an addition terminal.

The present invention relates to an Internet multimedia VOD system in which a specific frame is selected on the basis of the playback time axis of a multimedia file, the multimedia file 50 in which the one or more pause markers 51, the one or more pass markers 52, the one or more chapter markers 53, and the one or more skip markers 54 on which time codes thereof are recorded are defined and stored in the metadata region of the multimedia file is stored in the file storage means 35 of the Internet VOD server 61, the one or more client terminals 63 are coupled to the VOD server 61 through the Internet, each of the client terminal 63 selects and downloads the multimedia file stored in the Internet VOD server 61 and sequentially plays back the multimedia file so that a foreign language can be learnt.

The present invention relates to Internet web browser media player in which the client terminal 63 connected to the VOD server 61 over the Internet plays back a multimedia file. A specific frame is selected on the basis of the playback time axis of a multimedia file. The multimedia file 50 in which the one or more pause markers 51, the one or more pass markers 52, the one or more chapter markers 53, and the one or more skip markers 54 on which time codes thereof are recorded are defined and stored in the metadata region of the multimedia file is loaded into the file storage means 35 of the VOD server 61. The one or more client terminals 63 access the VOD server 61 through the Internet. The web browser media player selects and downloads the multimedia file stored in the Internet VOD server 61. In a method of playing back an Internet web browser media player file, in the playback setting step 10, the file number of times of playbacks and a pause release time are set in for convenience of learning of a learner. In the file playback step 12, the multimedia file 50 is selected and played back, and the multimedia file is repeatedly played back between the pause markers 51 by the number of times of playbacks set in the setting means 33. The control means 34 detects each of the marker frames, performs playback by passing through the multimedia file in the chapter markers 53, but may start the playback from a relevant part, performs the playback by passing through the multimedia file in the pass markers 52, but starts the playback from a relevant part when the multimedia file is rewound, skips the playback in the skip markers 54, and temporally stops the playback of the multimedia file in the pause markers 51 in the pause step 13. A learner directly answers a played sentence by using the pause time and performs various studies, such as shadowing or a dictation. Next, in the playback switch manipulation step 14, the pause of the multimedia file is released by manipulating the switch means 32. If the learner 25 does not perform the playback switch manipulation step 14 until the setting release time of the pause release step 15 set in the setting means 33, the pause key is automatically released in the pause release step 15. In the file playback step 12, the multimedia file is played back again. The pause step 13, the switch manipulation step 14, and the pause release step 15 are repeated to download the multimedia file 50 stored in the VOD server 61, and the one or more client terminals 63 sequentially plays back the multimedia file so that a foreign language can be learnt. The web browser media player of the present invention may be installed in a homepage of an Internet website, a bulletin board, a blog, and a webpage, such as a café in order to play back a multimedia file.

The present invention relates to a method of producing multimedia file content, in which in the multimedia playback program and the multimedia player 30, a specific frame is selected on the basis of the playback time axis of a multimedia file by using the content production marker program of the present invention, and the one or more pause markers 51 on which time codes thereof are recorded are recorded into the metadata region of the multimedia file in order to implement an effective learning function using a common multimedia file format.

The present invention relates to a method of producing multimedia file content, in which in the multimedia playback program and the multimedia player 30, a specific frame is selected on the basis of the playback time axis of a multimedia file by using the content production marker program of the present invention, the one or more pause markers 51, the one or more pass markers 52, the one or more chapter markers 53, and the one or more skip markers 54 on which time codes thereof are recorded are stored in the metadata region of a multimedia file in order to implement an effective learning function using a common multimedia file format.

The present invention relates to a method of producing multimedia file content, in which in the multimedia playback program and the multimedia player 30, a specific frame is selected on the basis of the playback time axis of a multimedia file by using the content production marker program of the present invention, and the one or more pause markers 51, the one or more pass markers 52, the one or more chapter markers 53, and the one or more skip markers 54 on which time codes thereof are recorded are defined and stored in the metadata region of the multimedia file in such a manner that, when the time codes are captured, a soundless part for some time or more is detected in the waveform data of the multimedia file 50, the pause markers 51 are inserted into front and rear or middle frames at once, erroneously inserted markers are deleted, and the location and type of the marker are modified, in order to implement an effective learning function using a common multimedia file format.

The present invention relates to a method of producing multimedia file content, in which in the multimedia playback program and the multimedia player 30, a script file having the same name as the multimedia file 50 is produced by using the content production marker program of the present invention and is enclosed in the same folder, a specific frame is selected on the basis of the playback time axis of the multimedia file 50, and the one or more pause markers 51, the one or more pass markers 52, the one or more chapter markers 53, and the one or more skip markers 54 on which time codes thereof are recorded are defined and stored in the script file in order to implement an effective learning function using a common multimedia file format.

The present invention a method of producing multimedia file content, in which in the multimedia playback program and the multimedia player 30, a script file having the same name as the multimedia file 50 is produced by using the content production marker program of the present invention and is enclosed in the same folder, a specific frame is selected on the basis of the playback time axis of the multimedia file 50, the pause markers 51, the pass markers 52, the chapter markers 53, and the skip markers 54 on which time codes thereof are recorded are defined, and the markers and the time code thereof are stored in the script file in such a manner that, when the time codes are captured, a soundless part for some time or more is detected in the waveform data of the multimedia file 50, the pause markers 51 are inserted into front and rear or middle frames at once, erroneously inserted markers are deleted, and the location and type of the marker are modified, in order to implement an effective learning function using a common multimedia file format.

The present invention relates to a method of producing a multimedia file, in which in the multimedia playback program and the multimedia player, a script file having the same name as the multimedia file 50 is produced by using the content production marker program of the present invention and is enclosed in the same folder, a specific frame is selected on the basis of the playback time axis of the multimedia file 50, and the pause markers 51, the pass markers 52, the chapter markers 53, and the skip markers 54 on which time codes thereof are recorded are defined and stored in the metadata region of the multimedia file in such a manner that when the time codes are captured, a specific frame to be used as a marker is extracted by parsing scripts, such as caption files lrc and smi, previously produced in order to be used the captions of the multimedia file, the pause marker 51 is inserted into the specific frame, an unnecessary marker is deleted, and the location and type of the marker is modified, in order to implement an effective learning function using a common multimedia file format.

The present invention relates to a method of producing multimedia file content, in which in the multimedia playback program and the multimedia player 30, when there is a file including an already produced caption script file having the same name as the multimedia file 50, the script file is fetched into the content production marker program of the present invention, and the marker and the time codes thereof are stored in the script file in such a manner that the time code of each caption is detected, the pause markers 51 are inserted into specific frames at the front and rear parts or a middle part at once, an erroneous marker is deleted, and the location of the markers and the chapter markers 53, the pass markers 52, and the skip markers 54 are modified, in order to implement an effective learning function using a common multimedia file format.

The present invention relates to a computer program in which the caption script file 60 loaded along with the multimedia file 50 is parsed, the time code of the caption in time tag 66 is defined as the pass marker 52, the time code of the caption out time tag 67 is defined as the pause marker 51, and the markers are stored in the metadata region of the multimedia file 50, in the method of playing back a multimedia program file.

The present invention relates to a computer-readable recording medium. In the multimedia program, the multimedia file 50 in which the pause markers 51, the pass markers 52, the chapter markers 53, the skip markers 54, and the variable markers 55 are defined and stored in the metadata region of the multimedia file 50 is fetched into and loaded into the program. The computer-readable recording medium includes a function of storing, in a specific format marker file, the markers and the time code data stored in the metadata region of the multimedia file 50.

The present invention relates to a computer-readable recording medium. In the multimedia program, the computer-readable recording medium includes a function of fetching the multimedia file 50, loading the multimedia file 50 into the program, fetching a specific format marker file in which the pause markers 51, the pass markers 52, the chapter markers 53, the skip markers 54, and the variable markers 55 are defined and stored, and storing the marker information in the metadata region of the multimedia file 50. As described above, if only the marker information is separately stored, fetched, and applied to and the multimedia file, there is an advantage in that the multimedia file can be fetched, directly marked, and stored without marking the multimedia file one by one when marking the multimedia file.

The present invention relates to a method of producing a multimedia disk, in which a specific frame is selected on the basis of the playback time axis of a disk track on which time codes thereof are recorded and the one or more chapter markers 53, the one or more pass markers 52, the one or more pause markers 51, and the one or more skip markers 54 are defined and stored in an information region, in the multimedia disk player. The disk may be fabricated as other disks, such as a CD and Blu-ray, as well as a DVD.

The script file used in the multimedia playback program and the multimedia player 30 of the present invention may be formed of not only a file format defined and produced in the present invention, but also lrc, smi, sub, ttxt, and srt caption files and txt, wri, doc, and html file formats.

The multimedia file 50 used in the multimedia playback program and the multimedia player 30 of the present invention may also be formed of MP3, WMA, Ogg, FLAC, AAC, ASF, M4A, AC3, and WAV files, AVI, WMV, ASF, MPEG4, H.264, AVC, VC1, MPG, MT2, MOV, ISO, VOB, SWF, SVCD, Dvix, Xvid, MKV, and fly files, and codec and container format multimedia files.

The multimedia player of the present invention may be formed of all multimedia devices for playing back the multimedia file 50, such as an MP3 player, an MP4 player, a digital audio player, a Portable Multimedia Player (PMP), a cellular phone, television (TV), a Personal Video Recorder (PVR), an electronic dictionary, a navigation system, a car audio, an E-book reader, a digital photo frame, a projector, a digital camera, a network player, a DVD player, a DVD recorder, a Blu-ray player, a Blu-ray recorder, a compact disk player, a divx player, a component audio system, a portable audio system, a Digital Multimedia Broadcasting (DMB) receiver, a radio, a recorder, a voice recorder, a Karaoke machine, an Internet telephone, a game machine for home, a portable game machine, a Personal Digital Assistant (PDA), a Mobile Internet Device (MID), an electronic blackboard, a microphone, an amplifier, an automatic broadcasting control system, a digital archive system, a computer, and a language study machine.

However, the drawings and the embodiments are for illustrative purposes, and the present invention is not limited thereto. Various modifications are possible without departing from the scope of the present invention. Accordingly, the scope of the present invention should not be limited to the described embodiments, but defined by the claims and their equivalents.

1. A method of playing back a multimedia file, comprising:
a file load step 9 of sorting multimedia files stored in a folder of an information storage medium in order of file name and loading the multimedia files into a playback program;
a file selection step 11 of selecting the multimedia file;
a file playback step 12 of playing back the selected multimedia file;
a pause step 13 of, when the playback of the multimedia file is ended, control means 34 temporally stopping the playback at an end part of the multimedia file 59;
a playback switch manipulation step 14 of releasing the pause by manipulating switch means 32 after studies are completed using a pause time; and
a file playback step 12 of playing back a next file,
wherein a foreign language is studied while repeating the file playback step 12, the pause step 13 of temporally stopping the playback, and the playback switch manipulation step 14 and sequentially playing back the multimedia files stored in the folder.

2. The method according to claim 1, further comprising:
a playback setting step 10 of setting a number of times of playbacks and a pause release time in setting means 33, wherein in the file playback step 12, the multimedia file is repeatedly played back by the set number of times of playbacks; and
a pause release step 15 of automatically releasing a pause key when the playback switch manipulation step 14 is not performed until the pause release time set in the file pause step 13.

3. The method according to claim 1, wherein the pause step 13 is the pause step 13 of temporally stopping the playback of the multimedia file when the control means 34 detects a soundless part for some time or more in an audio signal of the multimedia file.

4. A method of playing back a multimedia file:
a multimedia file 50 being played is the multimedia file 50 in which a specific frame is selected based on a playback time axis of the multimedia file and one or more pause markers 51 on which time codes thereof are recorded are defined and stored in a metadata region of the multimedia file,
a file load step 9 of loading the multimedia file 50, stored in an information storage medium, into a playback program;
a file selection step 11 of selecting the multimedia file 50;
a file playback step 12 of playing back the selected multimedia file 50;
a pause step 13 of control means 34 detecting the pause markers 51 and temporally stopping the playback at a relevant frame;
a playback switch manipulation step 14 of releasing the pause by manipulating the switch means 32, after completing studies using a pause time; and
a file playback step 12 of playing back the multimedia file again,
wherein a foreign language is studied while repeating the file playback step 12, the pause step 13 of temporally stopping the playback, and the playback switch manipulation step 14 and sequentially playing back the multimedia file 50.

5. The method according to claim 4, further comprising:
a playback setting step 10 of setting a number of times of playbacks and a pause release time in setting means 33, wherein in the file playback step 12, between-the pause markers 51 is repeatedly played back by the set number of times of playbacks; and
a pause release step 15 of automatically releasing a pause key when the playback switch manipulation step 14 is not performed until the pause release time set in the file pause step 13.

6. A method of playing back a multimedia file, comprising:
a multimedia file 50 being played is the multimedia file 50 in which a specific frame is selected based on a playback time axis of the multimedia file and one or more pause markers 51, one or more chapter markers 53, one or more pass markers 52, and one or more skip markers 54 on which time codes thereof are recorded are defined, and marker information is stored in a metadata region of the multimedia file,
a file load step 9 of loading the multimedia file, stored in an information medium, into a playback program;
a playback setting step 10 of setting means 33 setting a number of times of playbacks and a pause release time;
a file selection step 11 of selecting the multimedia file 50;
a file playback step 12 of playing back the selected multimedia file 50;
a pause step 13 of repeatedly playing back between-the pause markers 51 by the number of times of playbacks set in the setting means 33 in the file playback step 12, and control means 34 detecting each of the marker frames, performing playback by passing through the multimedia file in the chapter markers 53, but starting the playback from a relevant part, performing the playback by passing through the multimedia file in the pass markers 52, but starting the playback from a relevant part when the multimedia file is rewound, skipping the playback in the skip markers 54, and temporally stopping the playback of the multimedia file in the pause markers 51;
a playback switch manipulation step 14 of releasing the pause by manipulating the switch means 32, after completing studies using the pause time; and
a pause release step 15 of automatically releasing a pause key if the playback switch manipulation step 14 is not performed until the setting release time of the pause release step 15 previously set in the setting means 33 by a learner 25,
wherein a foreign language is studied while repeating the file playback step 12, the pause step 13, the playback switch manipulation step 14, and the pause release step 15 and sequentially playing back the multimedia file 50.

7. The method according to claim 6, wherein in the playback switch manipulation step 14, when specific voice is detected by microphone input means 39 in the pause step 13, the pause is released by the control means 34.

8. The method according to claim 6, wherein in the pause release step 15, the pause is released by the control means 34 if any voice signal is not detected by the microphone input means 39 for some time or more.

9. The method according to claim 6, wherein the control means further includes a function in which the learner 25 learns words and a sentence whose studies have been completed after repeatedly learning the words and the sentence several times while changing the pause markers 51 of the words and the sentence into the skip markers 54 by using the switch means 32 and then stores the pause markers 51 in the metadata region of the multimedia file 50 again.

10. The method according to claim 6, wherein:
the multimedia file 50 being played includes the multimedia file 50 in which a specific frame is selected based on a playback time axis of the multimedia file and one or more pause markers 51, one or more chapter markers 53, one or more pass markers 52, and one or more skip markers 54 on which time codes thereof are recorded are defined, and marker information is stored in a metadata region of the multimedia file, and a multimedia file 50B without a marker,
the multimedia files are sorted in the order of name and loaded into the playback program, and
the control means 34 includes a function of detecting each of the markers and performing control so that the chapter markers 53 are normally passed, but playback is started from a relevant part, the pass markers 52 are passed, but playback is performed from a relevant marker when the multimedia file is rewound, playback is skipped in the skip markers 54, the playback is paused in the pause markers 51, and when the multimedia file 50B without a marker is played back, a start part 58 of the multimedia file is passed and playback is performed like the chapter markers 53, but playback is started from a relevant part, and an end part of the multimedia file 59 is always paused like the pause markers 51.

11. The method according to claim 6, wherein:
the multimedia file 50 being played includes the multimedia file 50 in which a specific frame is selected based on a playback time axis of the multimedia file and one or more pause markers 51, the chapter markers 53, the pass markers 52, and the skip markers 54 on which time codes thereof are recorded are defined, and marker information is stored in a metadata region of the multimedia file, and a multimedia file 50B without a marker,
the multimedia files are sorted in the order of name to produce a playback list 70, and
start parts of the chapter markers 53 and the multimedia file 50B without a marker are listed up in the same order so that a desired chapter is immediately selected and played back.

12. The method according to claim 6, wherein:
the multimedia file 50 being played includes the multimedia file 50 in which a specific frame is selected based on a playback time axis of the multimedia file and the pause markers 51, the chapter markers 53, the pass markers 52, and the skip markers 54 on which time codes thereof are recorded are defined, and marker information is stored in a metadata region of the multimedia file, and a multimedia file 50B without a marker, and
in the file load step 9, the markers of the multimedia file 50 and the multimedia file 50B without a marker are randomly mixed and randomly loaded into the playback program.

13. The method according to claim 6, wherein:
the multimedia file 50 being played includes the multimedia file 50 in which a specific frame is selected based on a playback time axis of the multimedia file and the pause markers 51, the chapter markers 53, the pass markers 52, and the skip markers 54 on which time codes thereof are recorded are defined, and marker information is stored in a metadata region of the multimedia file, and
in the file playback step 12, control is performed so that a thumbnail image of each chapter markers is displayed when a part under a playback screen is selected, playback is started from a relevant chapter marker when a desired thumbnail is selected, a gauge bar indicating each marker is displayed in a playback scroll bar, and playback is started from a relevant marker when a desired gauge bar is selected.

14. The method according to claim 6, wherein:
the multimedia file 50 being played includes the multimedia file 50 in which a specific frame is selected based on a playback time axis of the multimedia file and the pause markers 51, the chapter markers 53, the pass markers 52, the skip markers 54, and variable markers 55 on which time codes thereof are recorded are defined, and marker information is stored in a metadata region of the multimedia file, and
the method further includes the playback setting step 10 of setting variable markers in the setting means 33, wherein the control means 34 includes a function of operating the variable markers 55 as the pause markers 51 when the learner 25 sets the variable markers 55 as the pause markers 51 in the setting means 33, skipping playback in a relevant marker when the learner 25 sets the variable markers 55 as the skip markers 54 in the setting means 33, and performing no function in a relevant marker when the learner 25 sets the variable markers 55 as invalidation in the setting means 33.

15. The method according to claim 6, wherein the control means 34 includes a circuit for fading in a start audio signal when a file is repeatedly played back and for fading out an end part audio when a file is paused is added, in order to prevent a sudden loud playback of the audio when between-the pause markers 51 is repeatedly played back in the file playback step 12.

16. The method according to claim 6, wherein the control means 34 includes a function of performing control so that playback is started from a specific frame in a rear part of a marker that is repeatedly played back, in order to prevent captions of a former marker from being displayed at a start part of the marker, when between-the pause markers 51 is repeatedly played back by the number of times of playbacks set in the file playback step.

17. The method according to claim 6, wherein the control means 34 includes a function of performing control so that playback is performed without a pause time in the number of times of playbacks at a former part and playback is paused by a pause time only in the number of times of playbacks at a last part, when between-the pause markers 51 is repeatedly played back by the number of times of playbacks set in the file playback step.

18. The method according to claim 6, wherein the multimedia file 50 being played is the multimedia file 50 produced by selecting a specific frame based on the playback time axis of the multimedia file, defining the one or more pause markers 51, the one or more pass markers 52, the one or more chapter markers 53, the one or more skip markers 54, and one or more caption markers on which time codes there are recorded, recording marker information on the metadata region of the multimedia file, and storing both image data or text in the caption markers.

19. The method according to claim 6, wherein:
the multimedia file 50 being played is the multimedia file 50 in which a specific frame is selected based on the playback time axis of the multimedia file and one or more caption pause markers 63, one or more caption chapter markers 61, and one or more caption pass markers 62 on which time codes thereof are recorded are defined and both caption text or image data of the markers are stored in the metadata region of the multimedia file, and
the control means 34 detects each of the caption marker frames and includes a function of performing playback by passing through the multimedia file in the caption chapter markers 61, but starting playback at a relevant part, performing playback by passing through the multimedia file in the caption pass markers 62, but starting playback from a relevant part when the multimedia file is rewound, and temporally stopping the playback in the caption pause markers 63, so that a foreign language is studied while sequentially playing back the multimedia file and superimposing captions.

20. The method according to claim 6, wherein:
the multimedia file 50 being played is the multimedia file 50 in which learning setting is defined in the metadata region of the multimedia file, a specific frame is selected based on the playback time axis of the multimedia file, and the one or more pause markers 51, the one or more pass markers 52, the one or more chapter markers 53, and the one or more skip markers 54 on which time codes thereof are recorded are defined and stored in the metadata region of the multimedia file, and
the control means 34 performs a function of playing the markers according to the learning setting in the metadata region of the multimedia file.

21. The method according to claim 6, wherein:
the multimedia file 50 being played is the multimedia file 50 in which a specific frame is selected based on the playback time axis of the multimedia file, the one or more pause markers 51, the one or more chapter markers 53, the one or more pass markers 52, and the one or more skip markers 54 on which time codes thereof are recorded are defined, the markers are divided into role-playing A and B groups, and marker information is stored in the metadata region of the multimedia file,
role-playing A and B learning setting are added in the playback setting step 10, and
the method includes a function in which, when the multimedia file 50 is played, an audio signal of the role-playing A group marker is muted and an audio signal of the role-playing B group marker is played back according to an original volume in the setting of the role-playing A, and the audio signal of the role-playing B group marker is muted and the audio signal of the role-playing A group marker is played back according to an original volume in the setting of the role-playing B, according to the role-playing set by the setting means 33.

22. The method according to claim 6, wherein wired and wireless remote controller switch means having a previous marker and a next marker switch is added outside a computer so that a learner can conveniently listen to or skip a learned sentence.

23. A method of playing back a multimedia file, comprising:
a file load step 9 of producing an additional script file having the same name as a multimedia file 50, selecting a specific frame based on a playback time axis of the multimedia file 50, defining one or more pause markers 51, one or more pass markers 52, one or more chapter markers 53, and one or more skip markers 54 on which time codes thereof are recorded, enclosing the script file in which the marker information is stored in the same folder as the multimedia file 50, and loading the script file, together with the multimedia file 50, into a playback program;
a playback setting step 10 of setting a number of times of playbacks and a pause release time in setting means 33;
a file selection step 11 of selecting the multimedia file 50;
a file playback step 12 of playing back the selected multimedia file 50;
a pause step 13 of, in the file playback step 12, the control means 34 detecting each of the marker frames of the script file, playing back the script file between the pause markers 51 by the number of times of playbacks set in the setting means 33, performing playback by passing through the script file in the chapter markers 53, but starting playback from a relevant part, performing playback by passing through the script file in the pass markers 52, but starting playback from a relevant part when the script file is rewound, skipping the playback in the skip markers 54, and temporally stopping the playback of the script file in the pause markers 51;
a playback switch manipulation step 14 of releasing the pause manipulating the switch means 32, after completing studies using a pause time; and
a pause release step 15 of automatically releasing a pause key, if the playback switch manipulation step 14 is not performed until the setting release time of the pause release step 15 previously set in the setting means 33 by a learner 25,
wherein a foreign language is studied while sequentially playing back the multimedia file 50 by detecting each of the markers recorded on the script file while repeating the file playback step 12 of playing back the multimedia file again, the pause step 13, the switch manipulation step 14, and the pause release step 15.

24. The method according to claim 23, wherein:
the multimedia file 50 being played is the multimedia file 50 enclosed in the same folder as an additional script file in which a specific frame is selected based on a playback time axis of the multimedia file 50 and the one or more pause markers 51, the one or more pass markers 52, the one or more chapter markers 53, the one or more skip markers 54, and one or more variable markers 55 on which time codes thereof are recorded are defined and stored, and the additional script file has the same name as the multimedia file 50,
the playback setting step 10 of setting variable markers is added to the setting means 33, and
the control means 34 detects each of the markers stored in the script file and includes a function of operating the variable markers 55 as the pause markers 51 when the learner 25 sets the variable markers 55 as the pause markers 51 in the setting means 33, skipping playback in a relevant marker when the learner 25 sets the variable markers 55 as the skip markers 54, and performing no function in a relevant marker when the learner 25 sets the variable markers 55 as invalidation.

25. The method according to claim 23, wherein the multimedia file 50 being played is the multimedia file 50 having the same name as a script file produced by selecting a specific frame based on the playback time axis of the multimedia file 50, defining the one or more pause markers 51, the one or more pass markers 52, the one or more chapter markers 53, the one or more skip markers 54, and caption markers on which time codes thereof are recorded, storing the markers in the script file having the same name as the multimedia file, and inserting caption text or a name and path of an image file to be associated with the caption markers.

26. The method according to claim 23, wherein:
the multimedia file 50 being played is the multimedia file 50 having the same name as a script file produced by selecting a specific frame based on the playback time axis of the multimedia file 50, defining one or more caption pause markers 63, one or more caption chapter markers 61, and one or more caption pass markers 62 on which time codes thereof are recorded, and inserting caption text or a name and path of an image file to be associated with the caption markers, and
the control means 34 detects each of the caption markers of the script file and includes a function of performing playback by passing through the script file in the caption chapter markers 61, but starting the playback in a relevant part, performs playback by passing through the script file in the caption pass markers 62, but starting playback from a relevant part when the script file is rewound, and temporally stopping the playback in the caption pause markers 63, so that a foreign language is studied by superimposing the captions while sequentially playing back the multimedia file.

27. A method of playing back a multimedia file, comprising:
a played file is a caption script file 60, including a caption in time tag 66 and a caption out time tag 67 and having the same name as a multimedia file 50,
a file load step of loading the two files, stored in an information storage medium, into a playback program;
a playback setting step 10 of setting a number of times of playbacks and a pause release time in setting means 33 for convenience of learning;
a file selection step 11 of selecting the file;
a file playback step 12 of playing the selected file;
a pause step 13 of control means 34 detecting time codes of the caption in time tag 66 and the caption out time tag 67 of the caption script file by the number of times of playbacks set in the setting means 33, repeatedly performing playback between the relevant frames of the multimedia file 50, performing playback by passing through the multimedia file in a frame of the caption in time tag 66, but starting playback from a relevant part when the multimedia file is repeatedly played back, and temporally stopping the playback of the multimedia file 50 in the caption out time tag 67;
a playback switch manipulation step 14 of releasing the pause of the multimedia file by manipulating the switch means 32, after completing studies using the pause time; and
a pause release step 15 of automatically releasing a pause key, if the playback switch manipulation step 14 is not performed until the release time of the pause release step 15 previously set in the setting means 33 by a learner 25,
wherein the multimedia file 50 is sequentially played back by detecting the time codes of the caption in time tag 66 and the caption out time tag 67 of the caption script file 60 while repeating the file playback step 12 of playing back the multimedia file again, the pause step 13, the switch manipulation step 14, and the pause release step 15.

28. The method according to claim 27, wherein in a method of playing back a multimedia file using the caption script file 60 for displaying a caption and excluding a previous caption by using only one kind of the caption time tag 68, a blank character string caption time tag 69 is inserted into a part from which the caption disappear, the multimedia file between the time codes of the caption time tag 68 and the blank character string caption time tag 69 is played back by the number of times of playbacks set in the setting means, playback is performed by passing through the multimedia file in the frame of the caption time tag 68, but playback is started from a relevant part when the multimedia file is repeatedly played back, and the playback of the multimedia file is paused in the blank character string caption time tag 69, and the multimedia file is sequentially played back.

29. The method according to claim 27, wherein in a method of playing back a multimedia file using the caption script file 60 for displaying a caption and excluding a previous caption by using only one kind of the caption time tag 68, the multimedia file between the time codes of the two caption time tags is played back by the number of times of playbacks set in the setting means, playback is performed by passing through the multimedia file in the frame of the caption time tag 68 first started, but playback is started from a relevant part when the multimedia file is repeatedly played back, the playback of the multimedia file is paused in the consecutive caption time tags 68b, and the multimedia file is sequentially played back.

30. A multimedia player, comprising:
playback switch means 32 for storing one or more multimedia files 50B in file storage means 35 through interface means 36, loading the one or more multimedia files 50B into a multimedia player, selecting the multimedia file, playing back the selected multimedia file, completing studies in the pause state, and then releasing the pause;
control means 34 for detecting an end part of the multimedia file 59, temporally stopping playback at a relevant frame, playing back the multimedia file again, temporally stopping the playback, and controlling a series of signals;
storage means 35 for storing the multimedia file;
analog conversion means 37 for converting decoded audio and video signals;
display means 31 for states operated by key manipulation, video, and text;
output means 38 for outputting the audio signal; and
interface means 36 for transmitting and receiving data to and from a computer,
wherein a foreign language is studied while sequentially playing back the multimedia file.

31. The multimedia player according to claim 30, further comprising setting means 33 for setting a number of times of playbacks and a pause release time for convenience of learning, wherein the control means 34 includes a function of repeatedly playing back the multimedia file by the number of times of playbacks set in the setting means 33 and automatically releasing a pause key if the playback switch means 32 is not performed until the set pause release time in the pause state.

32. The multimedia player according to claim 30, wherein the control means 34 includes a function of temporally stopping the playback of the multimedia file when a soundless part for some time or more is detected in the audio signal of the multimedia file.

33. A multimedia player, comprising:
a multimedia file 50 being played is the multimedia file 50 in which a specific frame is selected based on a playback time axis of the multimedia file and one or more pause markers 51 on which time codes thereof are recorded are defined and stored in a metadata region of the multimedia file,
playback switch means 32 for storing the multimedia file in file storage means 35 through interface means 36, loading the multimedia file into a multimedia player, selecting the multimedia file, and playing back the selected multimedia file or releasing the pause after completing studies in the pause state;
control means 34 for detecting pause markers 51 of the multimedia file, temporally stopping the playback in a relevant frame, playing back the multimedia file again, temporally stopping the playback, and controlling a series of signals;
the storage means 35 for storing the multimedia file;
analog conversion means 37 for converting decoded audio and video signals;
display means 31 for displaying states operated by key manipulation, video, and text;
output means 38 for outputting the audio signal; and
the interface means 36 for transmitting and receiving data to and from a computer,
wherein a foreign language is studied while sequentially playing back the multimedia file 50.

34. The multimedia player according to claim 33, further comprising setting means 33 for setting a number of times of playbacks and a pause release time for convenience of learning, wherein the control means 34 includes a function of repeatedly performing playback between the pause markers 51 by the number of times of playbacks set in the setting means 33 and automatically releasing a pause key if the playback switch means 32 is not performed until the set pause release time in the pause state.

35. A multimedia player, comprising:
a multimedia file 50 being played is the multimedia file 50 in which a specific frame is selected based on a playback time axis of the multimedia file and one or more pause markers 51, one or more pass markers 52, one or more chapter markers 53, and one or more skip markers 54 on which time codes thereof are recorded are defined, and the marker information is stored in a metadata region of the multimedia file,
file storage means 35 for storing the multimedia file through interface means 36 and loading the multimedia file into a multimedia player;
setting means 33 for setting a number of times of playbacks and a pause release time for convenience of learning;
playback switch means 32 for selecting the multimedia file and playing back the selected multimedia file or releasing pause after completing studies in the pause state;
control means 34 for playing back the multimedia file between the markers by the set number of times of playbacks, detecting each of the marker frames, performing playback by passing through the multimedia file in the chapter markers 53, but starting playback from a relevant part, performing playback by passing through the multimedia file in the pass markers 52, but starting playback from a relevant part when the multimedia file is rewound, skipping playback in the skip markers 54, temporally stopping the playback of the multimedia file in the pause markers 51, automatically releasing the pause key when the set pause release time is reached, playing back the multimedia file again, temporally stopping the playback, and controlling a series of signals;
the storage means 35 for storing the multimedia file;
analog conversion means 37 for converting decoded audio and video signals;
display means 31 for displaying states operated by key manipulation, video, and text;
output means 38 for outputting the audio signal; and
the interface means 36 for transmitting and receiving data to and from a computer,
wherein a foreign language is studied while sequentially playing back the multimedia file 50.

36. The multimedia player according to claim 35, wherein the control means 34 includes a function of releasing the pause key by detecting a specific voice signal through the microphone input means 39.

37. The multimedia player according to claim 35, wherein the control means 34 includes a function of releasing the pause key if any voice signal is not detected through the microphone input means 39 for some time or more in the pause state.

38. The multimedia player according to claim 35, wherein the control means further includes a function in which the learner 25 learns words and a sentence whose studies have been completed after repeatedly learning the words and the sentence several times while changing the pause markers 51 of the words and the sentence into the skip markers 54 by using the switch means 32 and then stores the pause markers 51 in the metadata region of the multimedia file 50 again.

39. The multimedia player according to claim 35, wherein:
the multimedia file 50 being played includes the multimedia file 50 in which a specific frame is selected based on a playback time axis of the multimedia file and one or more pause markers 51, one or more chapter markers 53, one or more pass markers 52, and one or more skip markers 54 on which time codes thereof are recorded are defined, and marker information is stored in the metadata region of the multimedia file, and a multimedia file 50B without a marker,
the multimedia files are sorted in the order of name and loaded into the playback program, and
the control means 34 includes a function of detecting each of the markers and performing control so that the chapter markers 53 are normally passed, but playback is started from a relevant part, the pass markers 52 are passed, but playback is performed from a relevant marker when the multimedia file is rewound, playback is skipped in the skip markers 54, the playback is paused in the pause markers 51, and when the multimedia file 50B without a marker is played back, a start part 58 of the multimedia file is passed and playback is performed like the chapter markers 53, but playback is started from a relevant part, and an end part of the multimedia file 59 is always paused like the pause markers 51.

40. The multimedia player according to claim 35, wherein:
the multimedia file 50 being played includes the multimedia file 50 in which a specific frame is selected based on a playback time axis of the multimedia file and one or more pause markers 51, the chapter markers 53, the pass markers 52, and the skip markers 54 on which time codes thereof are recorded are defined, and marker information is stored in a metadata region of the multimedia file, and a multimedia file 50B without a marker,
the multimedia files are sorted in the order of name to produce a playback list 70, and
start parts of the chapter markers 53 and the multimedia file 50B without a marker are listed up in the same order so that a desired chapter is immediately selected and played back.

41. The multimedia player according to claim 35, wherein:
the multimedia file 50 being played includes the multimedia file 50 in which a specific frame is selected based on a playback time axis of the multimedia file and the pause markers 51, the chapter markers 53, the pass markers 52, and the skip markers 54 on which time codes thereof are recorded are defined, and marker information is stored in a metadata region of the multimedia file, and a multimedia file 50B without a marker, and
the markers of the multimedia file 50 and the multimedia file 50B without a marker are randomly mixed and randomly loaded into the multimedia player.

42. The multimedia player according to claim 35, wherein:
the multimedia file 50 being played includes the multimedia file 50 in which a specific frame is selected based on a playback time axis of the multimedia file and the pause markers 51, the chapter markers 53, the pass markers 52, and the skip markers 54 on which time codes thereof are recorded are defined, and marker information is stored in a metadata region of the multimedia file, and
in a file playback state, control is performed so that a thumbnail image of each chapter markers is displayed when a part under a playback screen is selected, playback is started from a relevant chapter marker when a desired thumbnail is selected, a gauge bar indicating each marker is displayed in a playback scroll bar, and playback is started from a relevant marker when a desired gauge bar is selected.

43. The multimedia player according to claim 35, wherein:
the multimedia file 50 being played includes the multimedia file 50 in which a specific frame is selected based on a playback time axis of the multimedia file and the pause markers 51, the chapter markers 53, the pass markers 52, the skip markers 54, and variable markers 55 on which time codes thereof are recorded are defined, and marker information is stored in a metadata region of the multimedia file, and
the setting means 33 sets variable markers and includes a function of operating the variable markers 55 as the pause markers 51 when the learner 25 sets the variable markers 55 as the pause markers 51 in the setting means 33, skipping playback in a relevant marker when the learner 25 sets the variable markers 55 as the skip markers 54 in the setting means 33, and performing no function in a relevant marker when the learner 25 sets the variable markers 55 as invalidation in the setting means 33.

44. The multimedia player according to claim 35, wherein the control means 34 includes a circuit for fading in a start audio signal when a file is repeatedly played back and for fading out an end part audio when a file is paused is added, in order to prevent a sudden loud playback of the audio when between-the pause markers 51 is repeatedly played back in a file playback state.

45. The multimedia player according to claim 35, wherein the control means 34 includes a function of performing control so that playback is started from a specific frame in a rear part of a marker that is repeatedly played back, in order to prevent captions of a former marker from being displayed at a start part of the marker, when between-the pause markers 51 is repeatedly played back by the number of times of playbacks set in a file playback state.

46. The multimedia player according to claim 35, wherein the control means 34 includes a function of performing control so that playback is performed without a pause time in the number of times of playbacks at a former part and playback is paused by a pause time only in the number of times of playbacks at a last part, when between-the pause markers 51 is repeatedly played back by the number of times of playbacks set in the file playback state.

47. The multimedia player according to claim 35, wherein the multimedia file 50 being played is the multimedia file 50 produced by selecting a specific frame based on the playback time axis of the multimedia file, defining the one or more pause markers 51, the one or more pass markers 52, the one or more chapter markers 53, the one or more skip markers 54, and one or more caption markers on which time codes there are recorded, recording marker information on the metadata region of the multimedia file, and storing both image data or text in the caption markers.

48. The multimedia player according to claim 35, wherein:
the multimedia file 50 being played is the multimedia file 50 in which a specific frame is selected based on the playback time axis of the multimedia file and one or more caption pause markers 63, one or more caption chapter markers 61, and one or more caption pass markers 62 on which time codes thereof are recorded are defined and both caption text or image data of the markers are stored in the metadata region of the multimedia file.

49. The multimedia player according to claim 35, wherein:
the multimedia file 50 being played is the multimedia file 50 in which learning setting is defined in the metadata region of the multimedia file, a specific frame is selected based on the playback time axis of the multimedia file, and the one or more pause markers 51, the one or more pass markers 52, the one or more chapter markers 53, and the one or more skip markers 54 on which time codes thereof are recorded are defined and stored in the metadata region of the multimedia file, and
the control means 34 performs a function of playing the markers according to the learning setting in the metadata region of the multimedia file.

50. The multimedia player according to claim 35, wherein:
the multimedia file 50 being played is the multimedia file 50 in which a specific frame is selected based on the playback time axis of the multimedia file, the one or more pause markers 51, the one or more chapter markers 53, the one or more pass markers 52, and the one or more skip markers 54 on which time codes thereof are recorded are defined, the markers are divided into role-playing A and B groups, and marker information is stored in the metadata region of the multimedia file,
role-playing A and B learning setting are added in the setting means 33, and
the setting means 33 includes a function in which, when the multimedia file 50 is played, an audio signal of the role-playing A group marker is muted and an audio signal of the role-playing B group marker is played back according to an original volume in the setting of the role-playing A, and the audio signal of the role-playing B group marker is muted and the audio signal of the role-playing A group marker is played back according to an original volume in the setting of the role-playing B, according to the role-playing set by the setting means 33.

51. The multimedia player according to claim 35, wherein the switch means 32 further includes wired and wireless remote controller switch means having a previous marker and a next marker switch in addition to the multimedia player so that the learner can put the multimedia player in a bag and listen to or skip a studied sentence conveniently when doing studies while listening using an earphone.

52. The multimedia player according to claim 30, 33, or 35, wherein the switch means 32 includes a function of manipulating all parts of the display means 31 by using a touch panel playback switch so that the learner can conveniently release a file pause 13 without erroneous manipulation.

53. A multimedia player, comprising:
a multimedia file 50 being played is the multimedia file 50 enclosed in the same folder as an additional script file in which a specific frame is selected based on a playback time axis of the multimedia file and one or more pause markers 51 on which time codes thereof are recorded are defined, the script file having the same name as the multimedia file,
playback switch means 32 for storing the multimedia file in file storage means 35 through interface means 36, loading the multimedia file, together with the script file, into a multimedia player, selecting the multimedia file, and playing back the selected multimedia file or releasing pause after completing studies in the pause state;
control means 34 for detecting the pause markers 51 of the script file, temporally stopping playback in the relevant frame of the multimedia file, playing back the multimedia file again, temporally stopping the playback, and controlling a series of signals;
storage means 35 for storing the multimedia file;
analog conversion means 37 for converting decoded audio and video signals;
display means 31 for states operated by key manipulation, video, and text;
output means 38 for outputting the audio signal; and
interface means 36 for transmitting and receiving data to and from a computer,
wherein a foreign language is studied while sequentially playing back the multimedia file.

54. The multimedia player according to claim 53, further comprising setting means 33 for setting a number of times of playbacks and a pause release time for convenience of learning, wherein the control means 34 includes a function of repeatedly performing playback between the pause markers 51 by the number of times of playbacks set in the setting means 33 and automatically releasing a pause key if the playback switch means 32 is not executed until the pause release time set in the pause state.

55. A multimedia player, comprising:
a multimedia file 50 being played is the multimedia file 50 enclosed in the same folder as an additional script file in which a specific frame is selected based on a playback time axis of the multimedia file and one or more pause markers 51, one or more pass markers 52, one or more chapter markers 53, and one or more skip markers 54 on which time codes thereof are recorded are defined, the script file having the same name as the multimedia file,
setting means 33 for storing the multimedia file in file storage means 35 through interface means 36, loading the multimedia file, together with the script file, into a multimedia player, and setting a number of times of playbacks and a pause release time for convenience of learning;
playback switch means 32 for selecting the multimedia file playing back the selected multimedia file or releasing pause after completing studies in the pause state;
control means 34 for playing back between-the markers by the number of times of playbacks set in the file, detecting each of the marker frames, performing playback by passing through the multimedia file in the chapter markers 53, but starting playback from a relevant part, performing playback by passing through the multimedia file in the pass markers 52, but starting playback from a relevant part in when the multimedia file is rewound, skipping playback in the skip markers 54, temporally stopping the playback of the multimedia file in the pause markers 51, automatically releasing a pause key when the set pause release time is reached, playing back the multimedia file again, temporally stopping the playback, and controlling a series of signals;
storage means 35 for storing the multimedia file;
analog conversion means 37 for converting decoded audio and video signals;
display means 31 for states operated by key manipulation, video, and text;
output means 38 for outputting the audio signal; and
interface means 36 for transmitting and receiving data to and from a computer.

56. The multimedia player according to claim 55, wherein:
the multimedia file 50 being played is the multimedia file 50 enclosed in the same folder as an additional script file in which a specific frame is selected based on a playback time axis of the multimedia file 50 and the one or more pause markers 51, the one or more pass markers 52, the one or more chapter markers 53, the one or more skip markers 54, and one or more variable markers 55 on which time codes thereof are recorded are defined and stored, and the additional script file has the same name as the multimedia file 50,
the setting means 33 sets variable markers, and
the control means 34 detects each of the markers stored in the script file and includes a function of operating the variable markers 55 as the pause markers 51 when the learner 25 sets the variable markers 55 as the pause markers 51 in the setting means 33, skipping playback in a relevant marker when the learner 25 sets the variable markers 55 as the skip markers 54, and performing no function in a relevant marker when the learner 25 sets the variable markers 55 as invalidation.

57. The multimedia player according to claim 55, wherein the multimedia file 50 being played is the multimedia file 50 enclosed in the same folder as a script file having the same name as the multimedia file 50, and the script file is produced by selecting a specific frame based on the playback time axis of the multimedia file 50, defining the one or more pause markers 51 and caption markers on which time codes thereof are recorded, and inserting caption text or a name and path of an image file to be associated with the caption markers.

58. The multimedia player according to claim 55, wherein the multimedia file 50 being played is the multimedia file 50 enclosed in the same folder as a script file having the same name as the multimedia file 50, and the script file is produced by selecting a specific frame based on the playback time axis of the multimedia file 50, defining one or more caption pause markers 63, one or more caption chapter markers 61, and one or more caption pass markers 62 on which time codes thereof are recorded, and inserting caption text or a name and path of an image file to be associated with the caption markers.

59. A multimedia player, comprising:
a played file is a caption script file 60, including a caption in time tag 66 and a caption out time tag 67 and having the same name as a multimedia file 50,
setting means 33 for storing the two files in file storage means 35 through interface means 36, loading the two files into a multimedia player, and setting a number of times of playbacks and a pause release time for convenience of learning;
playback switch means 32 for selecting the multimedia file 50 and playing back the selected multimedia file 50 or releasing pause after completing studies in the pause state;
control means 34 for detecting the time codes of the caption in time tag 66 and the caption out time tag 67 of the caption script file 60, playing back between-relevant frames of the multimedia file 50 by the number of times of playbacks set in the setting means, performing playback by passing through the multimedia file in the caption in time tag 66, but starting playback from a relevant part when the multimedia file is repeatedly played back, temporally stopping the playback of the multimedia file in the frame of the caption out time tag 67, automatically releasing a pause key if the playback switch means 32 is not executed until the pause release time set in the setting means 33 in the pause state, and controlling a series of signals;
analog conversion means 37 for converting decoded audio and video signals;
display means 31 for displaying states operated by key manipulation, video, and text; and
output means 38 for outputting the audio signal,
wherein the multimedia file is sequentially played back by detecting the time codes of the caption in time tag 66 and the caption out time tag 67 of the caption script file 60.

60. The multimedia player according to claim 59, wherein in a method of playing back a multimedia file using the caption script file 60 for displaying a caption and excluding a previous caption by using only one kind of the caption time tag 68, a blank character string caption time tag 69 is inserted into a part from which the caption disappear, the multimedia file between the time codes of the caption time tag 68 and the blank character string caption time tag 69 is played back by the number of times of playbacks set in the setting means, playback is performed by passing through the multimedia file in the frame of the caption time tag 68, but playback is started from a relevant part when the multimedia file is repeatedly played back, and the playback of the multimedia file is paused in the blank character string caption time tag 69, and the multimedia file is sequentially played back.

61. The multimedia player according to claim 59, wherein in a method of playing back a multimedia file using the caption script file 60 for displaying a caption and excluding a previous caption by using only one kind of the caption time tag 68, the multimedia file between the time codes of the two caption time tags is played back by the number of times of playbacks set in the setting means, playback is performed by passing through the multimedia file in the frame of the caption time tag 68 first started, but playback is started from a relevant part when the multimedia file is repeatedly played back, the playback of the multimedia file is paused in the consecutive caption time tags 68b, and the multimedia file is sequentially played back.

62. The multimedia player according to claims 59 to 61, wherein the caption script file 60 loaded together with the multimedia file 50 is parsed, the time code of the caption in time tag 66 is defined and set as the pass marker 54, the time code of the caption out time tag 67 is defined and set as the pause marker 51, and the time codes are stored in the metadata region of the multimedia file 50.

63. A multimedia disk player, comprising:
setting means 33 for loading a disk in which a specific frame is selected based on a playback time axis of a disk track and one or more pause markers 51 on which time codes thereof are recorded are defined and stored in an information region into a multimedia disk player and for setting a number of times of playbacks and a pause release time for convenience of learning;
switch means 32 for selecting a track of the disk and playing back the selected track or releasing pause after completing studies in the pause state;
control means 34 for repeatedly performing playback by the number of times of playbacks set in the setting means 33, detecting the pause markers 51 of the disk, temporally stopping playback in a relevant frame, releasing a pause key if the playback switch means 32 is not performed until the pause release time, playing back the disk, temporally stopping the playback, and controlling a series of signals;
analog conversion means 37 for converting decoded video and audio signals;
display means 31 for displaying states operated by key manipulation; and
output means 38 for outputting the video and audio signals,
wherein a foreign language is studied while sequentially playing back the video and audio.

64. The multimedia disk player according to claim 63, wherein:
a played disk is a disk in which a specific frame is selected based on a playback time axis of the disk and one or more pause markers 51, one or more chapter markers 53, one or more pass markers 52, and one or more skip markers 54 on which time codes thereof are recorded are defined and stored in an information region, and
the control means 34 including a function of performing playback by passing through the disk in the chapter markers 53, but starting playback, performing playback by passing through the disk in the pass markers 52, but performing playback in a relevant part when the multimedia file is rewound, skipping the playback of the disk in the skip markers 54, and temporally stopping the playback of the disk in the pause markers 51.

65. A multimedia VOD system,
wherein a multimedia file 50 being played is the multimedia file 50 in which a specific frame is selected based on a playback time axis of the multimedia file and one or more pause markers 51, one or more pass markers 52, one or more chapter markers 53, and one or more skip markers 54 on which time codes thereof are recorded are defined and stored in a metadata region of the multimedia file, and
the multimedia file is stored in file storage means 35 of a VOD server 71, one or more client terminals 73 are connected to the VOD server 71 over a network 72, and the client terminal 73 selects and loads the multimedia file stored in the VOD server 71,
the multimedia VOD system comprising:
setting means 33 for setting a number of times of playbacks and a pause release time in the client terminal 73 for convenience of learning;
playback switch means 32 of the client terminal 73 for selecting and playing back the multimedia file 50 or releasing pause after completing studies in the pause state;
control means 34 of the VOD server 71 for playing back the multimedia file by the set number of times of playbacks, detecting each of the marker frames, performing playback by passing through the multimedia file in the chapter markers 53, but starting playback from a relevant part, performing playback by passing through the multimedia file in the pass markers 52, but starting playback from a relevant part when the multimedia file is rewound, skipping playback in the skip markers 54, temporarily stopping the playback of the multimedia file in the pause markers 51, automatically releasing a pause key if the playback switch means 32 is not performed until the pause release time set in the setting means 33 in the pause state, and controlling a series of signals;
analog conversion means 37 for converting decoded audio and video signals;
display means 31 for displaying states operated by key manipulation, video, and text; and
output means 38 for outputting the audio signal,
wherein a foreign language is studied while the one or more client terminals 73 connected to the VOD server 71 sequentially play back the multimedia file.

66. The multimedia VOD system according to claim 63, wherein the one or more client terminals 73 are connected to the VOD server 71 through an Internet, and the one or more client terminals 73 sequentially play back the multimedia file of the VOD server 71 so that a foreign language is studied.

67. A method of an Internet web browser media player playing back a multimedia file, comprising:
a multimedia file 50 being played is the multimedia file 50 in which a specific frame is selected based on a playback time axis of the multimedia file and one or more pause markers 51, one or more pass markers 52, one or more chapter markers 53, and one or more skip markers 54 on which time codes thereof are recorded are defined and stored in a metadata region of the multimedia file,
a file load step 9 of a client terminal 73, connected through an Internet, downloading and loading the multimedia file stored in the VOD server 71;
a playback setting step 10 of setting a number of times of playbacks and a pause release time for convenience of learning;
a file selection step 11 of selecting the multimedia file;
a file playback step 12 of playing back the multimedia file;
wherein between-the pause markers 51 is repeatedly played back by the number of times of playbacks set in the setting means, and the control means detects each of the markers, performs playback by passing through the multimedia file in the chapter markers 53, but starts playback from a relevant part, performs playback by passing through the multimedia file in the pass markers 52, but starts playback from a relevant part when the multimedia file is rewound, and skips the playback in the skip markers 54,
a pause step 13 of temporally stopping the playback of the multimedia file in the pause markers 51;
a playback switch manipulation step 14 of releasing pause by manipulating the switch means after directly answering a played sentence using the pause time or completing various studies, such as follow or a dictation; and
a pause release step 15 of automatically releasing a pause key if the playback switch manipulation step 14 is not performed until the setting release time of the pause release step 15 previously set in the setting means 33,
wherein the file playback step 12 of playing back the multimedia file again, the pause step 13, the switch manipulation step 14, and the pause release step 15 are repeated, the multimedia file 50 stored in the VOD server 71 is downloaded, and the one or more client terminals 73 sequentially plays back the multimedia file so that a foreign language is studied.

68. A computer-readable recording medium on which a program for executing any one of methods according to claims 1 to 24 is recorded.

69. The computer-readable recording medium according to claim 68, including a function of selecting a specific frame based on a playback time axis of the multimedia file 50, defining pause markers 51, pass markers 52, chapter markers 53, and skip markers 54 on which time codes thereof are recorded, and storing the markers in a metadata region of the multimedia file, so that a foreign language can be studied while playing back, temporally stopping, and again sequentially playing back the multimedia file in a multimedia playback program and a multimedia player 30.

70. The computer-readable recording medium according to claim 68, including a function of selecting a specific frame based on a playback time axis of the multimedia file 50, defining pause markers 51, pass markers 52, chapter markers 53, and skip markers 54 on which time codes thereof are recorded, designating frames in middle parts as the pause markers 51 at once by detecting a soundless part for some time or more in waveform data of the multimedia file 50 when each of the markers is captured, deleting an erroneously designated marker, modifying a location and type of the marker, and storing the modified marker in a metadata region of the multimedia file, so that a foreign language can be studied while playing back, temporally stopping, and again sequentially playing back the multimedia file in a multimedia playback program and a multimedia player 30.

71. The computer-readable recording medium according to claim 68, including a function of procuring a script file having the same name as a multimedia file 50, enclosing the script file in the same folder as the multimedia file 50, selecting a specific frame based on a playback time axis of the multimedia file 50, defining pause markers 51, pass markers 52, chapter markers 53, and skip markers 54 on which time codes thereof are recorded, and storing the markers in the script file, so that a foreign language can be studied while playing back, temporally stopping, and again sequentially playing back the multimedia file in a multimedia playback program and a multimedia player 30.

72. The computer-readable recording medium according to claim 68, including a function of procuring a script file having the same name as a multimedia file 50, enclosing the script file in the same folder as the multimedia file 50, selecting a specific frame based on a playback time axis of the multimedia file 50, defining pause markers 51, pass markers 52, chapter markers 53, and skip markers 54 on which time codes thereof are recorded, designating frames in middle parts as the pause markers 51 at once by detecting a soundless part for some time or more in waveform data of the multimedia file 50 when each of the markers is captured, deleting an erroneously designated marker, modifying a location and type of the marker, and storing the modified marker in a metadata region of the multimedia file, so that a foreign language can be studied while playing back, temporally stopping, and again sequentially playing back the multimedia file in a multimedia playback program and a multimedia player 30.

73. The computer-readable recording medium according to claim 68, including a function of selecting a specific frame based on a playback time axis of a multimedia file 50, defining pause markers 51, pass markers 52, chapter markers 53, and skip markers 54 on which time codes thereof are recorded, extracting a specific frame to be used as a marker by parsing scripts of caption files previously fabricated for use as a caption of the multimedia file when the time code is captured, inserting the pause marker 51 into the extracted specific frame, deleting an unnecessary marker, modifying a location and type of the marker, and recording the modified marker in a metadata region of the multimedia file, so that a foreign language can be studied while playing back, temporally stopping, and again sequentially playing back the multimedia file in a multimedia playback program and a multimedia player 30.

74. The computer-readable recording medium according to claim 68, including a function of, when there is a file in which a caption script file having the same name as a multimedia file 50 is already written, extracting a specific frame to be used as a marker by fetching and parsing the script file, designating the extracted specific frame as a pause marker 51, deleting an erroneously designated marker, modifying a location and type of the marker, and recording the marker on the script file, so that a foreign language can be studied while playing back, temporally stopping, and again sequentially playing back the multimedia file in a multimedia playback program and a multimedia player 30.

75. The computer-readable recording medium according to claims 27 to 29, including a function of parsing the caption script file 60 loaded along with the multimedia file 50, defining the time code of the caption in time tag 66 as the pass marker 54 and the time code of the caption out time tag 67 as the pause marker 51, and storing the time codes in a metadata region of the multimedia file 50.

76. A computer-readable recording medium, including a function of loading a multimedia file 50, having pause markers 51, pass markers 54, chapter markers 53, skip markers 52, and variable markers 55 defined therein and stored in a metadata region of the multimedia file, into a program and storing a type and time code data of the marker as a specific format marker file.

77. A computer-readable recording medium, including a function of fetching and loading a multimedia file 50, fetching a specific format marker file in which pause markers 51, pass markers 54, chapter markers 53, skip markers 52, and variable markers 55 are defined and stored, and storing each of pieces of marker information in a metadata region of the multimedia file 50.

78. A disk recording medium recordable by a multimedia disk player according to claim 64, wherein the disk recording medium is produced by selecting a specific frame based on a playback time axis of a disk track, defining one or more chapter markers 53, one or more pass markers 52, one or more pause markers 51, and one or more skip markers 54 on which time codes thereof are recorded, and storing the markers in an information region of a disk so that the disk recording medium can be played back in the multimedia disk player.
